(19) United States
(12) Patent Application Publication
(10) Pub. No.: US 2019/0025940 A1
(43) Pub. Date: Jan. 24, 2019

(54) WATCH-TYPE MOBILE TERMINAL AND METHOD OF OPERATION THEREOF

(71) Applicant: LG ELECTRONICS INC., Seoul (KR)

(72) Inventors: Hongjo SHIM, Seoul (KR); Jungwook HWANG, Seoul (KR); Joungsun BAE, Seoul (KR); Myungwon KIM, Seoul (KR); Youngmo KIM, Seoul (KR)

(73) Assignee: LG ELECTRONICS INC., Seoul (KR)

(21) Appl. No.: 16/071,468

(22) PCT Filed: Jan. 22, 2016
(86) PCT No.: PCT/KR2016/000718

§ 371 Date: Jul. 19, 2018

(51) Int. Cl. G06F 3/03; G04G 21/00; G06F 3/0362

(52) U.S. Cl. CPC G06F 3/0312; G06F 3/0362; G04G 21/00

(57) ABSTRACT

A watch-type mobile terminal according to an embodiment of the present invention includes: a stem including a shaft of a round rod shape made of a metal material; a sensing unit for recognizing a reflection pattern of the metal material, which is formed by irradiating light onto the shaft and reflecting the light on the surface of the shaft; and a control unit for recognizing the operation of the stem on the basis of the reflection pattern of the metal material and controlling the watch-type mobile terminal in response to the operation of the stem.

### TECHNICAL FIELD

The present invent relates to a watch-type mobile terminal and an operating method thereof. More particularly, the present invention relates to a watch-type mobile terminal employing a novel crown structure, which allows the movement of a crown without engraving a fine pattern, and a method of recognizing the crown structure, and an operating method thereof.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

A mobile terminal may be extended to a wearable device which is wearable on a body beyond the dimension that a user uses the mobile terminal while holding the mobile terminal with the hand of the user. The wearable device includes a watch-type mobile terminal, a glass-type mobile terminal, a head mounted display, or the like.

A watch-type mobile terminal includes a crown. When the crown is pressed or rotated, the watch-type terminal may control various applications (apps) or functions corresponding to the pressing or the rotating of the crown.

In general, to recognize the movement of the crown, numerous fine patterns are engraved on a shaft included in the crown. In this case, since the thickness of the shaft has to be increased in order to engrave the fine patterns, the thickness and the size of the crown may be increased. In addition, since fine patterns are engraved by a laser, an expensive material cost and high technologies are required. In addition, the probability that the failure rate occurs

In addition, as described above, according to the crown structure and the method of recognizing the movement of the crown, when the crown is pulled out, the pulled-out crown may not be recognized.

### DISCLOSURE

### Technical Problem

The present invention is to provide a watch-type mobile terminal and a method of operating the same, in which a crown structure allowing recognizing the movement of the crown without the fine pattern engraved therein and a method of recognizing the same are employed.

In addition, the present invention is to provide a mobile terminal and a method of operating the same, capable of employing a wheel key based on the above crown structure and the method of recognizing the same and substituting a rear key provided on a rear surface of a conventional mobile terminal with the wheel key.

The applicable scope of the present invention will be apparent from the following detailed description. However, since various modifications and changes can be understood to those skilled in the art within the scope of the inventive concept, the detailed description and a specific embodiment such as an exemplary embodiment of the present invention are provided for the illustrative purpose.

### Technical Solution

According to an embodiment of the present invention, a watch-type mobile terminal includes a crown including a shaft including a metal material and having a cylindrical rod shape, a sensing unit to irradiate light to the shaft and recognize a reflective pattern of the metal material, which is formed as the light is reflected from a surface of the shaft, and a controller to recognize an operation of the crown based on the reflective pattern of the metal material and control the watch-type mobile terminal corresponding to the operation of the crown.

According to another embodiment of the present invention, a mobile terminal includes a wheel key provided at a side surface of the mobile terminal, including a metal material, and having a circular shape, a sensing unit to irradiate light to the wheel key and recognize a reflective pattern of the metal material, which is formed as the light is reflected from a surface of the wheel key, and a controller to recognize an operation of the wheel key based on the reflective pattern of the metal material and control the mobile terminal corresponding to the operation of the wheel key.

According to still another embodiment of the present invention, a method of operating a watch-type mobile terminal may include irradiating light to a shaft included in a crown, including a metal material, and having a cylindrical rod shape, recognizing a reflective pattern of the metal material, which is formed as the light is reflected from a surface of the shaft, recognizing the operation of the crown based on the reflective pattern of the metal material, and controlling the watch-type mobile terminal corresponding to the operation of the crown.

### Advantageous Effects

According to at least one of embodiments of the present invention, the movement of the crown may be recognized without fine patterns engraved in the surface of the shaft. Accordingly, the size and the thickness of the crown may be reduced by reducing the thickness of the shaft. The material cost and the technology level for fine machining necessary to engrave the fine patterns may be reduced and the failure rate may be lowered.

In addition, according to at least one of embodiments of the present invention, the wheel key based on the novel crown structure is provided on the side surface of the mobile terminal instead of removing the rear key provided on the rear surface of the mobile terminal, thereby reducing the thickness of the mobile terminal and the rear-surface area in which the battery is mounted may be increased. Accordingly, the battery capacity may be increased.

### DESCRIPTION OF DRAWINGS

FIG. 1 is a block diagram illustrating a mobile terminal according to the present invention.

FIG. 2 is a schematic view illustrating another example of a mobile terminal 200 which is able to be modified according to the present invention.

FIG. 3 is a perspective view illustrating one example of a watch-type mobile terminal 300 according to another embodiment of the present invention.

FIG. 4 is a perspective view illustrating one example of a glass-type mobile terminal according to another exemplary embodiment of the present invention.

FIGS. 5A and 5B are views illustrating the structure of a crown provided in a watch-type mobile terminal according to one embodiment of the present invention.

FIGS. 6A to 6D are views illustrating the structure of a crown provided in a typical mobile terminal and a method of recognizing the movement of the crown.

FIG. 7 is view illustrating the detailed structure of the crown provided in the watch-type mobile terminal according to an embodiment of the present invention.

FIGS. 8A to 8C are views illustrating a speckle pattern of a shaft according to an embodiment of the present invention.

FIG. 9 is a view illustrating the structure of a sensor to recognize the speckle of the shaft in the watch-type mobile terminal according to an embodiment of the present invention.

FIG. 10 is a view illustrating the procedure of performing the computation for recognizing the movement of the shaft in the watch-type mobile terminal according to an embodiment of the present invention.

FIGS. 11A to 11D are views illustrating the method of recognizing the movement of the shaft in the watch-type mobile terminal according to an embodiment of the present invention.

FIGS. 12A to 12C are views illustrating the operations of the crown that may be recognized by the watch-type mobile terminal according to an embodiment of the present invention.

FIGS. 13A and 13B are views illustrating the method of controlling the watch-type mobile terminal according to an embodiment of the present invention.

FIGS. 14A to 14C are views illustrating a method of controlling the watch-type mobile terminal according to an embodiment of the present invention.

FIGS. 15A to 15C are views illustrating a method of controlling a watch-type mobile terminal according to an embodiment of the present invention.

FIGS. 16A to 16C are views illustrating a method of controlling a watch-type mobile terminal according to an embodiment of the present invention.

FIGS. 17A to 17D are views illustrating the structure of a typical mobile terminal.

FIGS. 18A to 18C are views illustrating a mobile terminal according to an embodiment of the present invention and the structure of a wheel key included in the mobile terminal.

FIGS. 19A to 19B are views illustrating one example of a wheel key region included in a mobile terminal according to an embodiment of the present invention.

FIGS. 20A and 20B are views illustrating another example of a wheel key region included in a mobile terminal according to an embodiment of the present invention.

FIGS. 21A to 21D are views illustrating one example of a wheel key included in a mobile terminal according to an embodiment of the present invention.

FIGS. 22A and 22B are views illustrating one example of a wheel key region included in a mobile terminal according to an embodiment of the present invention.

FIGS. 23A and 23B are views illustrating a wheel key region included in the mobile terminal according to an embodiment of the present invention.

FIGS. 24A and 24B are views for comparing a mobile terminal according to an embodiment of the present invention with a typical mobile terminal in thickness.

FIGS. 25A and 25B are views for comparing a mobile terminal according to an embodiment of the present invention with a typical mobile terminal in thickness.

FIG. 26 is a view illustrating an example of controlling a mobile terminal by using a wheel key according to an embodiment of the present invention

FIGS. 27A to 27C are views illustrating an example of controlling a mobile terminal by using according to an embodiment of the present invention.

FIGS. 28A to 28C are views illustrating one example that a mobile terminal according to an embodiment of the present invention is controlled by a wheel key.

FIG. 29 is a view illustrating a control method of a mobile terminal and a watch-type mobile terminal according to an embodiment of the present invention.

### BEST MODE

### Mode for Invention

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

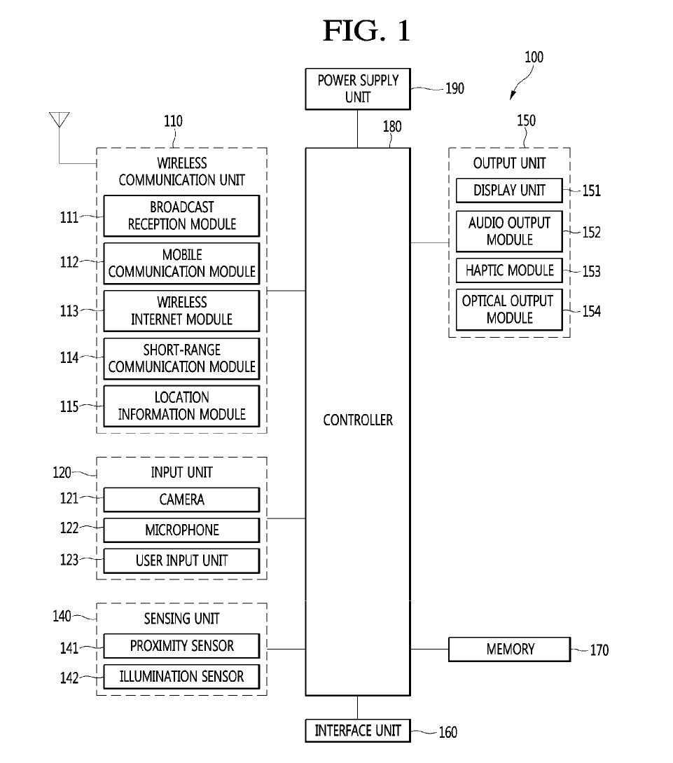

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like. Reference is now made to FIG. 1, where FIG. 1 is a block diagram of a mobile terminal in accordance with the present disclosure.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1, or activating application programs stored in the memory 170.

As one example, the controller 180 controls some or all of the components illustrated in FIG. 1 according to the execution of an application program that have been stored in the memory 170. Further, the controller 180 operates at least two of components included in the mobile terminal 100 by combining the at least two of components in order to execute the application program.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least a portion of the components may operate together to implement the operation, the control, or the control method of the mobile terminal according to various embodiment to be described below. In addition, the operation, the control, or the control method of the mobile terminal may be implemented on the mobile terminal by executing at least one application program stored in the memory 170

Referring still to FIG. 1, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be a server which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, and a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, the controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In addition, the display unit 151 may have at least two display units depending on the implementation form of the mobile terminal 100. In this case, in the mobile terminal 100, a plurality of display units may be separated from each other on one plane or provided integrally with each other. In addition, the display units may be individually provided on mutually different planes.

The display unit 151 may include at least one of a liquid crystal display (LCD), a thin film transistor-liquid crystal display (TFT LCD), an organic light-emitting diode (OLED), a flexible display, a 3D display, and an e-ink display.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

A communication system which is operable with the variously described mobile terminals will now be described in more detail.

Such a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (UMTS) (including, Long Term Evolution (LTE), LTE-A (Long Term Evolution-Advanced)), Global System for Mobile Communications (GSM), and the like.

By way of a non-limiting example only, further description will relate to a CDMA communication system, but such teachings apply equally to other system types including a CDMA wireless communication system as well as OFDM (Orthogonal Frequency Division Multiplexing) wireless communication system.

A CDMA wireless communication system generally includes one or more mobile terminals (MT or User Equipment, UE) 100, one or more base stations (BSs, NodeB, or evolved NodeB), one or more base station controllers (BSCs), and a mobile switching center (MSC). The MSC is configured to interface with a conventional Public Switched Telephone Network (PSTN) and the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs can be included in the CDMA wireless communication system.

Each base station may include one or more sectors, each sector having an omni-directional antenna or an antenna pointed in a particular direction radially away from the base station. Alternatively, each sector may include two or more different antennas. Each base station may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In some cases, the term “base station” may be used to refer collectively to a BSC, and one or more base stations. The base stations may also be denoted as “cell sites.” Alternatively, individual sectors of a given base station may be referred to as cell sites.

A broadcasting transmitter (BT) transmits a broadcast signal to the mobile terminals 100 operating within the system. The broadcast receiving module 111 of FIG. 1 is typically configured inside the mobile terminal 100 to receive broadcast signals transmitted by the BT.

Global Positioning System (GPS) satellites for locating the position of the mobile terminal 100, for example, may cooperate with the CDMA wireless communication system. Useful position information may be obtained with greater or fewer satellites than two satellites. It is to be appreciated that other types of position detection technology, (i.e., location technology that may be used in addition to or instead of GPS location technology) may alternatively be implemented. If desired, at least one of the GPS satellites may alternatively or additionally be configured to provide satellite DMB transmissions.

The location information module 115 is generally configured to detect, calculate, or otherwise identify a position of the mobile terminal. As an example, the location information module 115 may include a Global Position System (GPS) module, a Wi-Fi module, or both. If desired, the location information module 115 may alternatively or additionally function with any of the other modules of the wireless communication unit 110 to obtain data related to the position of the mobile terminal.

A typical GPS module 115 can measure an accurate time and distance from three or more satellites, and accurately calculate a current location of the mobile terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites. Furthermore, the GPS module can acquire speed information in real time to calculate a current position. Sometimes, accuracy of a measured position may be compromised when the mobile terminal is located in a blind spot of satellite signals, such as being located in an indoor space. In order to minimize the effect of such blind spots, an alternative or supplemental location technique, such as Wi-Fi Positioning System (WPS), may be utilized.

The Wi-Fi positioning system (WPS) refers to a location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module.

The Wi-Fi positioning system may include a Wi-Fi location determination server, a mobile terminal 100, a wireless access point (AP) connected to the mobile terminal 100, and a database stored with wireless AP information.

The mobile terminal connected to the wireless AP may transmit a location information request message to the Wi-Fi location determination server.

The Wi-Fi location determination server extracts the information of the wireless AP connected to the mobile terminal 100, based on the location information request message (or signal) of the mobile terminal 100. The information of the wireless AP may be transmitted to the Wi-Fi location determination server through the mobile terminal 100, or may be transmitted to the Wi-Fi location determination server from the wireless AP.

The information of the wireless AP extracted based on the location information request message of the mobile terminal 100 may include one or more of media access control (MAC) address, service set identification (SSID), received signal strength indicator (RSSI), reference signal received Power (RSRP), reference signal received quality (RSRQ), channel information, privacy, network type, signal strength, noise strength, and the like.

The Wi-Fi location determination server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only a predetermined number of wireless AP information in order of high RSSI.

Then, the Wi-Fi location determination server may extract (analyze) location information of the mobile terminal 100 using at least one wireless AP information extracted from the database.

A method for extracting (analyzing) location information of the mobile terminal 100 may include a Cell-ID method, a fingerprint method, a trigonometry method, a landmark method, and the like.

The Cell-ID method is used to determine a position of a wireless AP having the largest signal strength, among peripheral wireless AP information collected by a mobile terminal, as a position of the mobile terminal. The Cell-ID method is an implementation that is minimally complex, does not require additional costs, and location information can be rapidly acquired. However, in the Cell-ID method, the precision of positioning may fall below a desired threshold when the installation density of wireless APs is low.

The fingerprint method is used to collect signal strength information by selecting a reference position from a service area, and to track a position of a mobile terminal using the signal strength information transmitted from the mobile terminal based on the collected information. In order to use the fingerprint method, it is common for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless APs, signal strength may be converted into distance information, Time of Arrival (ToA), Time Difference of Arrival (TDoA), Angle of Arrival (AoA), or the like may be taken for transmitted wireless signals.

The landmark method is used to measure a position of a mobile terminal using a known landmark transmitter.

In addition to these position location methods, various algorithms may be used to extract (analyze) location information of a mobile terminal.

Such extracted location information may be transmitted to the mobile terminal 100 through the Wi-Fi location determination server, thereby acquiring location information of the mobile terminal 100.

The mobile terminal 100 can acquire location information by being connected to at least one wireless AP. The number of wireless APs required to acquire location information of the mobile terminal 100 may be variously changed according to a wireless communication environment within which the mobile terminal 100 is positioned.

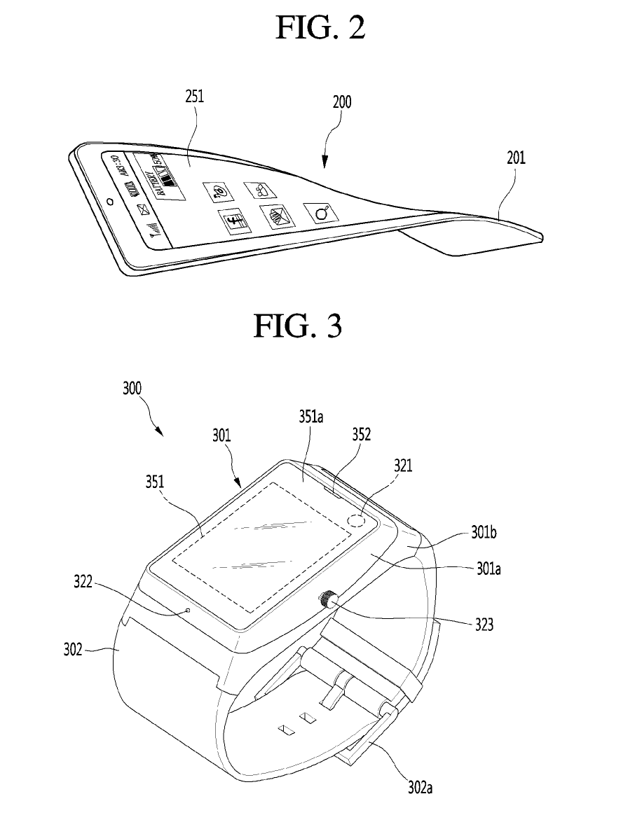

FIG. 2 is a conceptual view of a deformable mobile terminal according to an alternative embodiment of the present invention.

In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In general, mobile terminal 200 may be configured to include features that are the same or similar to that of mobile terminal 100 of FIG. 1.

The flexible display of mobile terminal 200 is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When in a state that the flexible display unit 251 is not deformed (for example, in a state with an infinite radius of curvature and referred to as a first state), a display region of the flexible display unit 251 includes a generally flat surface. When in a state that the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized in such a manner that a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, when an external force is applied to the flexible display unit 251, the flexible display unit 251 may transition to the second state such that the flexible display unit is deformed into the flat state (or a less curved state) or into a more curved state.

If desired, the flexible display unit 251 may implement a flexible touch screen using a touch sensor in combination with the display. When a touch is received at the flexible touch screen, the controller 180 can execute certain control corresponding to the touch input. In general, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140.

The deformation sensor may be located in the flexible display unit 251 or the case 201 to sense information related to the deforming of the flexible display unit 251. Examples of such information related to the deforming of the flexible display unit 251 may be a deformed direction, a deformed degree, a deformed position, a deformed amount of time, acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some embodiments, the controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251.

A battery (not shown in this figure) located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

In accordance with still further embodiments, a mobile terminal may be configured as a device which is wearable on a human body. Such devices go beyond the usual technique of a user grasping the mobile terminal using their hand. Examples of the wearable device include a smart watch, a smart glass, a head mounted display (HMD), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, when the sensed wearable device is a device which is authenticated to communicate with the mobile terminal 100, the controller 180 may transmit data processed in the mobile terminal 100 to the wearable device via the short-range communication module 114, for example. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

FIG. 3 is a perspective view illustrating one example of a watch-type mobile terminal 300 in accordance with another embodiment.

As illustrated in FIG. 3, the watch-type mobile terminal 300 includes a main body 301 with a display unit 351 and a band 302 connected to the main body 301 to be wearable on a wrist. In general, mobile terminal 300 may be configured to include features that are the same or similar to that of mobile terminal 100 of FIG. 1A.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some embodiments, the display unit 351 includes a touch sensor so that the display unit can function as a touch screen. As illustrated, window 351a is positioned on the first case 301a to form a front surface of the terminal body together with the first case 301a.

The illustrated embodiment includes audio output module 352, a camera 321, a microphone 322, and a user input unit 323 positioned on the main body 301. When the display unit 351 is implemented as a touch screen, additional function keys may be minimized or eliminated. For example, when the touch screen is implemented, the user input unit 323 may be omitted.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In one configuration, the band 302 may be used for extending the performance of the antenna. For example, the band may include therein a ground extending portion (not shown) electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

Meanwhile, according to an embodiment of the present invention, the user input unit 323 may be realized with a crown.

The crown 323 may have a rotatable button. In this case, the crown 323 may be rotated clockwise or counterclockwise, and may be pushed toward the center of the watch-type mobile terminal 300 or be pulled out of the watch-type mobile terminal 300 by pressure. To correspond to the above operations, the crown 323 not only may adjust time, a date, and a day, but also may control various applications (apps) or functions to be executed in the watch-type mobile terminal 300.

The crown 323 may be positioned at a side surface of the watch-type mobile terminal 300 such that the user easily handles the crown 323. In FIG. 3, the crown 323 may be positioned at a right side surface of the watch-type mobile terminal 300. However, the present invention is not limited thereto. According to the embodiment, the crown 323 may be positioned at a left side surface of the watch-type mobile terminal 300.

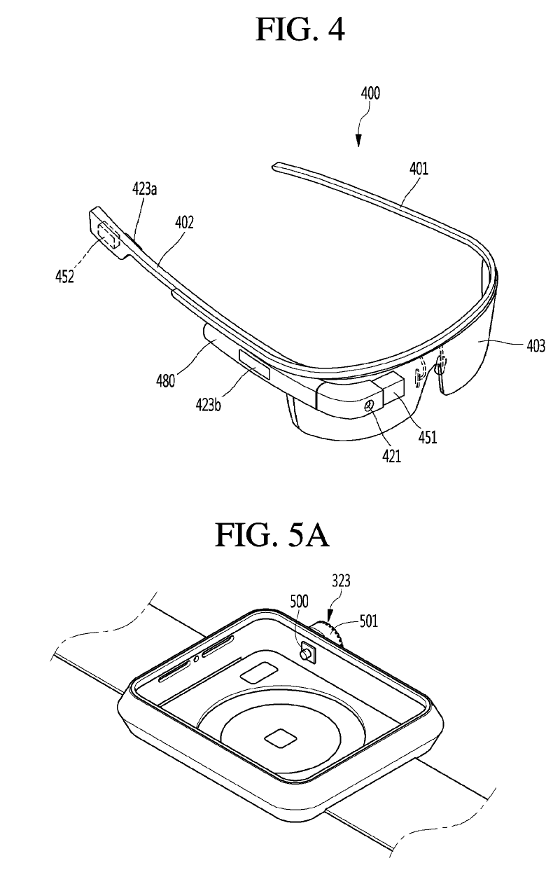

FIG. 4 is a perspective view illustrating one example of a glass-type mobile terminal 400 according to another exemplary embodiment.

The glass-type mobile terminal 400 can be wearable on a head of a human body and provided with a frame (case, housing, etc.) therefor. The frame may be made of a flexible material to be easily worn. The frame of mobile terminal 400 is shown having a first frame 401 and a second frame 402, which can be made of the same or different materials. In general, mobile terminal 400 may be configured to include features that are the same or similar to that of mobile terminal 100 of FIG. 1.

The frame may be supported on the head and defines a space for mounting various components. As illustrated, electronic components, such as a control module 480, an audio output module 452, and the like, may be mounted to the frame part. Also, a lens 403 for covering either or both of the left and right eyes may be detachably coupled to the frame part.

The control module 480 controls various electronic components disposed in the mobile terminal 400. The control module 480 may be understood as a component corresponding to the aforementioned controller 180. FIG. 4 illustrates that the control module 480 is installed in the frame part on one side of the head, but other locations are possible.

The display unit 451 may be implemented as a head mounted display (HMD). The HMD refers to display techniques by which a display is mounted to a head to show an image directly in front of a user's eyes. In order to provide an image directly in front of the user's eyes when the user wears the glass-type mobile terminal 400, the display unit 451 may be located to correspond to either or both of the left and right eyes. FIG. 4 illustrates that the display unit 451 is located on a portion corresponding to the right eye to output an image viewable by the user's right eye.

The display unit 451 may project an image into the user's eye using a prism. Also, the prism may be formed from optically transparent material such that the user can view both the projected image and a general visual field (a range that the user views through the eyes) in front of the user.

In such a manner, the image output through the display unit 451 may be viewed while overlapping with the general visual field. The mobile terminal 400 may provide an augmented reality (AR) by overlaying a virtual image on a realistic image or background using the display.

The camera 421 may be located adjacent to either or both of the left and right eyes to capture an image. Since the camera 421 is located adjacent to the eye, the camera 421 can acquire a scene that the user is currently viewing.

In the present drawing, the camera 421 is provided in the control module 480 for the illustrative purpose, the present invention is not limited thereto. The camera 421 may be installed in the frame unit and a plurality of cameras are provided to acquire a stereoscopic image.

The glass-type mobile terminal 400 may include user input units 423a and 423b, which can each be manipulated by the user to provide an input. The user input units 423a and 423b may employ techniques which permit input via a tactile input. Typical tactile inputs include a touch, push, or the like. The user input units 423a and 423b are shown operable in a pushing manner and a touching manner as they are located on the frame part and the control module 480, respectively.

In addition, a glass-type mobile terminal 400 may include a microphone (not illustrated) which processes input sound into electric audio data, and an audio output module 452 for outputting audio. The audio output module 452 may be configured to produce audio in a general audio output manner or an osteoconductive manner. When the audio output module 452 is implemented in the osteoconductive manner, the audio output module 452 may be closely adhered to the head when the user wears the mobile terminal 400 and vibrate the user's skull to transfer sounds.

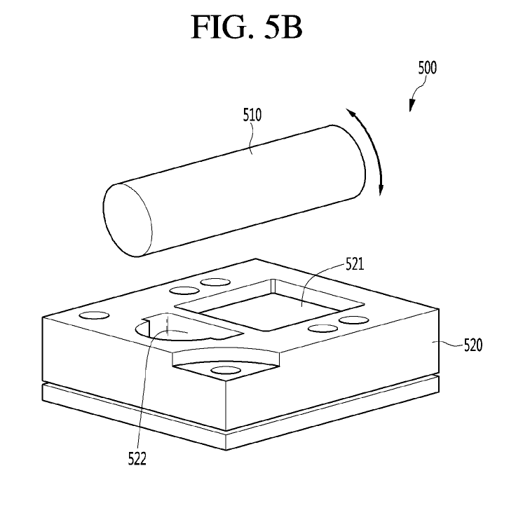

Regarding mobile terminals 100, 200, 300, and 400 configured as illustrated in FIGS. 1 to 4, the present invention suggests a novel structure of the crown 323 in which more various operations of the crown 323 may be recognized and the thickness and the width of the crown 323 may be reduced. Hereinafter, the novel structure of the crown 323 and the watch-type mobile terminal 300 employing the crown 323 having the novel structure will be described in detail with reference to FIGS. 5A to 16B. The following description will be made with reference to FIGS. 5A to 16B on the assumption that the crown 323 having the novel structure is applied to the watch-type mobile terminal 300 illustrated in FIG. 3 for the convenience of explanation. However, the present invention is not limited thereto. The novel structure of the crown 323 suggested in the present invention is applicable to the mobile terminal 100 illustrated in FIG. 1, the mobile terminal 200 illustrated in FIG. 2, and the mobile terminal 400 illustrated in FIG. 4.

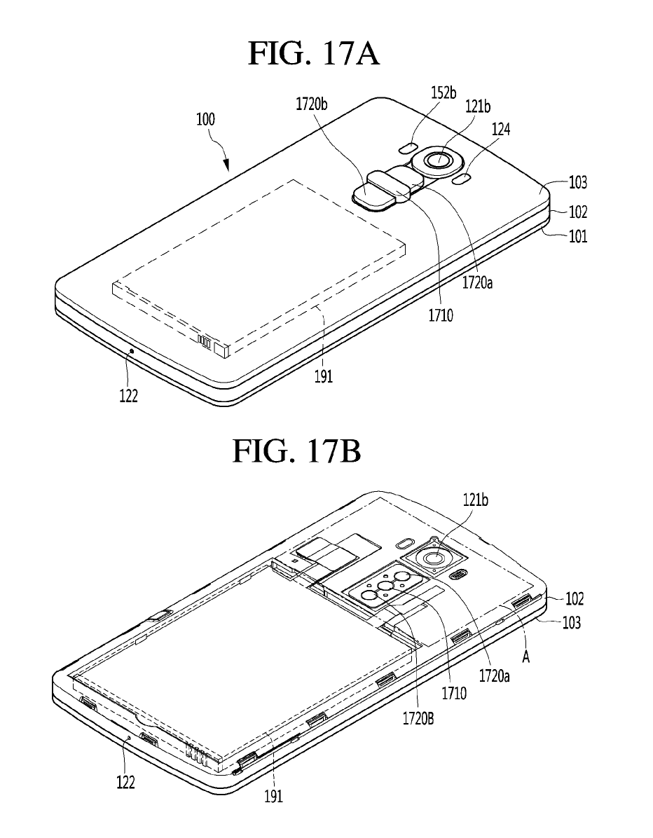

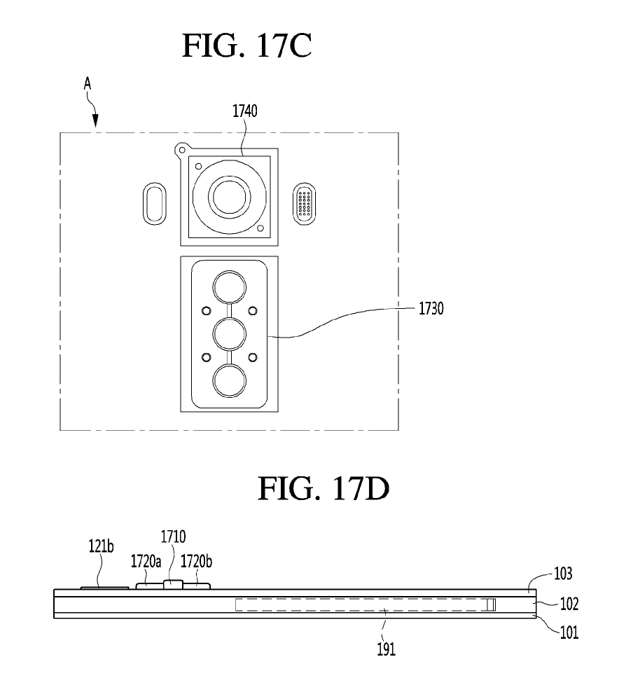

Meanwhile, the wheel key may be realized based on the novel structure of the crown 323. The wheel key may be substituted for a button key positioned on a rear surface of the mobile terminal 100. Accordingly, the space of the rear surface on which the battery is mounted may be widened, the capacity of the battery may be increased, and the thickness of the mobile terminal 100 may be reduced. Hereinafter, the wheel key based on the novel structure of the crown 323 and the mobile terminal 100 provided on a side surface thereof with the wheel key will be described in detail with reference to FIGS. 17A to 29. The following description will be made with reference to FIGS. 17A to 29 on the assumption that the wheel key based on the novel structure of the crown 323 is applied to the mobile terminal 100 illustrated in FIG. 1 for the convenience of explanation. However, the present invention is not limited thereto. For example, the wheel key based on the novel structure of the crown 323 suggested in the present invention is applicable to the mobile terminal 200 illustrated in FIG. 2, the mobile terminal 300 illustrated in FIG. 3, and the mobile terminal 400 illustrated in FIG. 4.

Hereinafter, embodiments related to a mobile terminal having configured as described above and a control method implemented in the mobile terminal will be described with reference to accompanying drawings. In addition, it should be obvious to those skilled in the art that various modifications of the present invention are possible without deviating from the spirit of the present invention and the essential technical feature of the present invention.

FIGS. 5A and 5B are views illustrating the structure of a crown provided in a watch-type mobile terminal according to one embodiment of the present invention.

The crown 323 may be positioned on a side surface of the mobile terminal 300.

The crown 323 may include a rotating unit 501 and a movement recognizing unit 500. In this case, the rotating unit 501 may be mounted on an outer portion of a case of the watch-type mobile terminal 300 and the movement recognizing unit 500 may be mounted in an inner portion of the case in which the electronic components of the watch-type mobile terminal 300 are embedded.

The rotating unit 501 and the movement recognizing unit 500 may be coupled to each other. According to an embodiment, the rotating unit 501 and the movement recognizing unit 500 may be coupled to each other by a fixing shaft passing through the centers of the rotating unit 501 and the movement recognizing unit 500. Accordingly, the movement recognizing unit 500 may detect the movement of the rotating unit 501.

The rotating unit 501 may have a wheel form. The rotating unit 501 may be rotated clockwise or counterclockwise about the fixing shaft.

In addition, the rotating unit 501 may be pulled out of a position in which the rotating unit 501 is mounted on an outer portion of the case or be pressed toward the center of the watch-type mobile terminal 300, corresponding to the pressure applied to the rotating unit 501 from the outside.

Referring to FIG. 5A, the electronic components of the watch-type mobile terminal 300 may be embedded in the space defined in the case. In this case, the rotating unit 501 may be mounted at the outer portion of the case and the movement recognizing unit 500 may be positioned at the inner portion of the case corresponding to the rotating unit 501.

FIG. 5B illustrates the detailed structure of the movement recognizing unit 500. The movement recognizing unit 500 may include a shaft 510 and a package circuit board 520.

The shaft 510 may be a cylindrical rod transmitting power. The shaft 510 may be formed of a metallic material. According to an embodiment, the shaft 510 may be coupled to the rotating unit 501 by the fixing shaft passing through the central portion of the shaft 510. Accordingly, the shaft 510 may be rotated, pressed toward the center of the watch-type mobile terminal 300, or pulled out of the watch-type mobile terminal 300, corresponding to the movement of the rotating unit 500.

The package circuit board 520 may be configured in the form in which a chip or module-type parts are mounted on a printed circuit board (PCB). The package circuit board 520 may have a light receiving unit 521 and a light irradiating unit 522 mounted thereon to detect the movement of the shaft 510.

The light receiving unit 521 may receive light reflected from the surface of the shaft 510. In this case, the reflected light may have a predetermined reflective pattern corresponding to the surface material of the shaft 510. Since the surface material of the shaft 510 may be varied depending on regions, the reflective pattern recognized by the light receiving unit 521 may be varied depending on the rotation of the shaft 510. The watch-type mobile terminal 300 may determine the rotation direction, the rotation speed, and the movement direction of the shaft 510, based on the shape and the shift degree of the reflective pattern recognized by the light receiving unit 521. The details thereof will be described below.

The light irradiating unit 522 may emit light and may irradiate light onto the shaft 510.

The light may include a laser, an infrared light, an ultraviolet light, and a light emitting diode (LED) light. The light irradiated by the light irradiating unit 522 may be varied depending on the material of the shaft 510. In the present invention, it is assumed that the light irradiating unit 522 irradiates laser for the convenience of explanation, but the present invention is not limited thereto.

Referring to FIG. 5B, the movement recognizing unit 500 may be provided at a lower portion thereof with the package circuit board 520 and the shaft 510 may be positioned above the package circuit board 520. In this case, the light irradiated from the light irradiating unit 522 of the package circuit board 520 to the shaft 510 may be reflected from the surface of the shaft 510 and received by the light receiving unit 521.

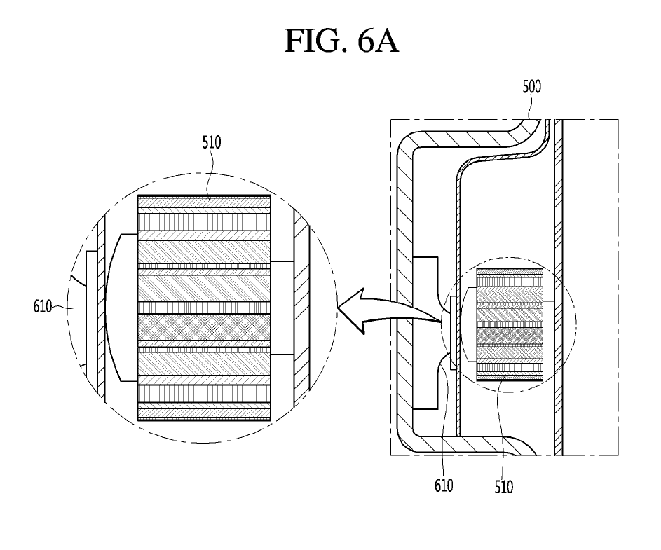

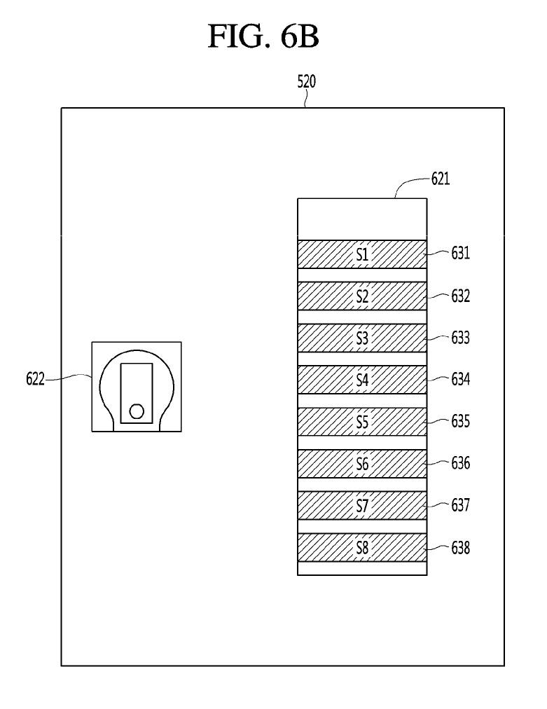

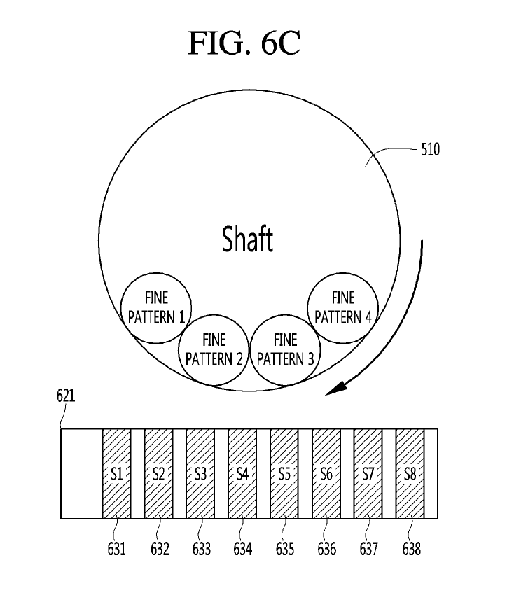

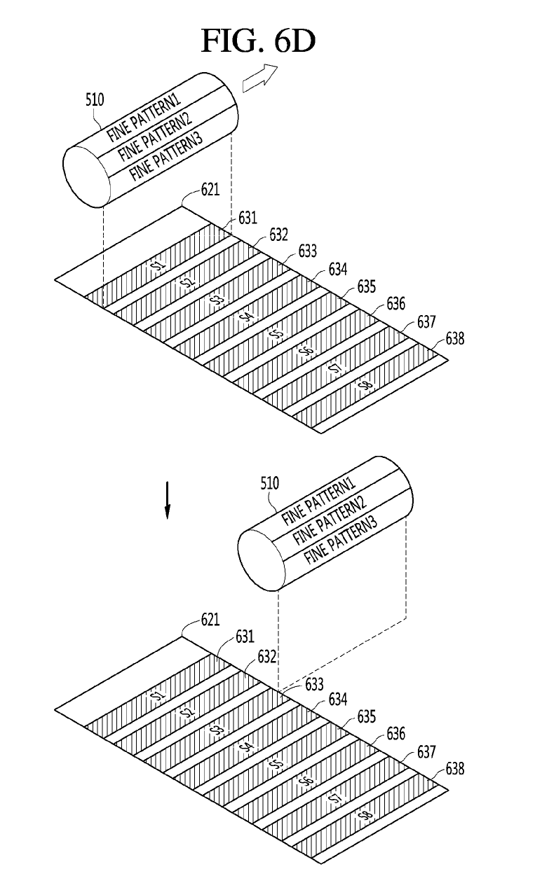

FIGS. 6A to 6D are views illustrating the structure of a crown provided in a typical mobile terminal and a method of recognizing the movement of the crown.

FIG. 6A illustrates an internal structure of the movement recognizing unit 500 and an enlarged view of the movement recognizing unit 500. As illustrated in FIG. 6A, the movement recognizing unit 500 may include the shaft 510 and a dome switch 610.

A plurality of fine patterns may be engraved on the surface of the shaft 510. The fine patterns may have mutually different shapes such that the fine patterns are distinguished from each other. For example, the fine patterns may be engraved on the surface of the shaft 510 in a line unit. In this case, various reflective patterns may be formed depending on the positions of lines irradiated with light.

The dome switch 610 may be a metal dome having elasticity. To this end, the dome switch 610 may be formed of a metal material having elasticity.

The dome switch 610 may be compressed corresponding to the pressure applied by the shaft 510. When predetermined time elapses in the state that the dome switch 610 is compressed, the dome switch 610 may be returned to an original state thereof by the elasticity.

The enlarged view of the shaft 510 is illustrated on a left side of FIG. 6A. As illustrated at the left side of FIG. 6A, a plurality of fine patterns may be engraved on the surface of the shaft 510. The fine patterns may have mutually different shapes and may be distinguished therebetween due to the mutually different shapes. The fine patterns may be graved in a horizontal direction and the fine patterns having mutually different shapes may be engraved in a line unit.

FIG. 6B is a view illustrating the structure of a package circuit board on which parts are mounted.

A sensor module 621 may be mounted on the light receiving unit 521 of the package circuit board 520. The sensor module 621 may receive light reflected from the shaft 510 and thus recognize the reflective pattern formed by the reflected light.

To this end, the sensor module 621 may include a plurality of sensors. In this case, each sensor may receive reflected light reaching the area for the sensor.

The light irradiating unit 522 of the package circuit board 520 may have an infrared LED 622. The infrared LED 622 may generate an infrared LED light to irradiate the shaft 510, which is positioned above the infrared LED 622, with the infrared LED light.

Referring to FIG. 6B, the sensor module 621 includes eight sensors, that is, a first sensor 631, a second sensor 632, a third sensor 633, a fourth sensor 634, a fifth sensor 635, a sixth sensor 636, a seventh sensor 637, and an eighth sensor 638. The eight sensors may be provided corresponding to the fine patterns engraved on the shaft 510 in a line direction.

FIG. 6C illustrates a method of recognizing the fine pattern of the shaft 510.

The reflected light may have a predetermined reflective pattern corresponding to the fine pattern engraved on the surface of the shaft 510. Since the fine pattern engraved on the surface of the shaft 510 may be varied according to lines, different reflective patterns may be recognized by the eight sensors 631, 632, 633, 634, 635, 636, 637, and 638, respectively, as the shaft 510 is rotated. The watch-type mobile terminal 300 may determine the rotation direction and the rotation speed of the shaft 510, based on the shape and the shift degree of the reflective pattern recognized by each of the eight sensors 631, 632, 633, 634, 635, 636, 637, and 638.

As illustrated in FIG. 6C, the shaft 510 has fine pattern 1, fine pattern 2, fine pattern 3, and fine pattern 4 engraved in a line unit. In this state, when the shaft 510 is rotated counterclockwise about the fixing shaft, each of the eight sensors 631, 632, 633, 634, 635, 636, 637, and 638 recognizes the reflective pattern from reflected light received in the relevant sensor.

The first sensor 631 recognizes reflective sensors in the sequence of reflective patterns of fine pattern 1, fine pattern 2, fine pattern 3, and fine pattern 4.

The second sensor 632 recognizes reflective sensors in the sequence of reflective patterns of fine pattern 2, fine pattern 3, and fine pattern 4.

In this case, the reflective patterns, the sequence of the reflective patterns, and the movement directions are mutually differently recognized by the first sensor 631 and the second sensor 632. Accordingly, the watch-type mobile terminal 300 may recognize the shift degree of the reflective pattern and thus may determine the rotation degree of the shaft 510.

FIG. 6D illustrates that the crown 323 is pulled out and thus the shaft 510 is moved outwards.

The crown 323 may be pulled out of the watch-type mobile terminal 300. When the crown 323 is pulled out, the shaft 510 may be moved outward.

As illustrated in FIG. 6D, the sensor module 621 including a plurality of sensors may be arranged corresponding to a plurality of fine patterns engraved on the surface of the shaft 510 in a line direction. In this case, when the shaft 510 is rotated clockwise or counterclockwise, the sensors included in the sensor module 621 may recognize reflective patterns reflected by the fine patterns engraved on the surface of the shaft 510.

When the crown 323 is pulled out, the shaft 510 is moved outward. Accordingly, the shaft 510 may be positioned at a region in which the sensor module 621 is not positioned. In this case, the light reflected by the fine patterns engraved on the surface of the shaft 510 reaches the region in which the sensor module 621 is not positioned. Accordingly, each of eight sensors 631, 632, 633, 634, 635, 636, 637, and 638 included in the sensor module 621 may not recognize the reflective patterns reflected from the fine patterns engraved on the shaft 510.

As described above, according to the conventional structure of the crown 323 and the conventional method of recognizing the movement of the crown 323, when the crown is pulled out, the shift of the reflective pattern recognized by the sensor module 621 may not occur. Accordingly, the watch-type mobile terminal 300 may not recognize the movement of the crown 323 pulled out.

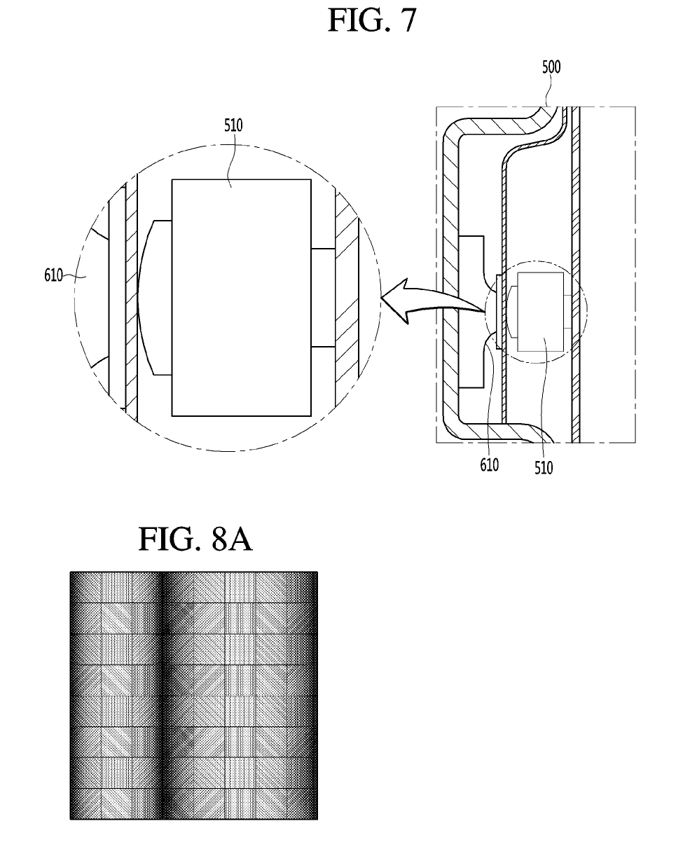

FIG. 7 is view illustrating the detailed structure of the crown provided in the watch-type mobile terminal according to an embodiment of the present invention.

As illustrated in FIG. 7, the movement recognizing unit 500 of the crown 323 may include the shaft 510 and the dome switch 610.

The shaft 510 may be a cylindrical rod transmitting power. The shaft 510 may be formed of a metallic material. Different from the shaft 510 included in the conventional crown 323, the fine patterns are not engraved on the shaft 510.

Accordingly, the shaft 510 may be rotated, pressed toward the center of the watch-type mobile terminal 300, or pulled out, corresponding to the movement of the rotating unit 500.

The dome switch 610 may be a metal dome having elasticity. To this end, the dome switch 610 may be formed of a metal material having elasticity.

The dome switch 610 may be compressed corresponding to the pressure applied by the shaft 510. When predetermined time elapses in the state that the dome switch 610 is compressed, the dome switch 610 may be returned to an original state thereof by the elasticity.

The enlarged view of the shaft 510 is illustrated at the left side of FIG. 7. As illustrated at the left side, fine patterns are not engraved on the surface of the shaft 510. Accordingly, the surface of the shaft 510 may be formed in a flat shape.

Conventionally, numerous fine patterns are densely engraved on the surface of the shaft 510 to recognize the movement of the crown 323. In this case, since the shaft 510 has to be formed with a thicker thickness to engrave the fine patterns, the thickness and the size of the crown 323 have to be increased. In addition, since the fine patterns are engraved by a laser, the high cost of materials and high-level technologies are required and the probability of the failure is increased.

The present invention suggests a method of recognizing the movement of the crown 323 without engraving the fine patterns on the surface of the shaft 510. Accordingly, since it is unnecessary to increase the size and the thickness of the shaft 510, the size and the thickness of the crown may be reduced. In addition, the material cost and the level of a technology for fine machining required to engrave the fine pattern may be reduced and the probability of the failure may be lowered.

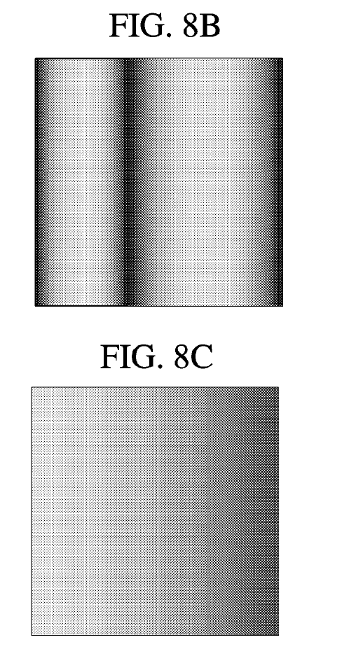

FIGS. 8A to 8C are views illustrating a speckle pattern of a shaft according to an embodiment of the present invention.

According to the present invention, the shaft 510 may be formed of a metal material. Since the fine patterns are not engraved on the surface of the shaft 510, the surface of the shaft 510 may be viewed as being in the flat shape. However, when the surface of the shaft 510 is enlarged, the surface of the shaft 510 is not uniform due to the characteristic of the metal material and has irregularities. Accordingly, when uniform light such as a laser beam is irradiated on the surface of the shaft 510, as light portions scattered from the uniform light interfere with each other, the inherent pattern of the relevant metal material appears. The inherent pattern may be called speckle.

The speckle may appear differently depending on metal materials. The speckle may appear differently depending on regions in the same metal material. According to the present invention, the movement of the crown 323 is recognized by using the speckle pattern of the shaft 510 instead of the conventional fine pattern.

FIG. 8A illustrates a speckle of an aluminum material. FIG. 8B illustrates a speckle of white paper. FIG. 8C illustrates a speckle of an article positioned at a remote place.

When the aluminum surface is irradiated with uniform light, the speckle pattern having the shape as illustrated in FIG. 8A appears. The pattern shapes may be varied depending on regions of the speckle, and the same patterns are not repeated. Accordingly, the rotation direction and the rotation degree of the shaft 510 may be determined based on the speckle of the aluminum.

When the white paper is irradiated with the uniform light, the speckle appears as illustrated in FIG. 8B. When the article at the remote place is irradiated with the uniform light, the speckle appears as illustrated in FIG. 8C. The speckle patterns illustrated in FIGS. 8B and 8C have uniform shapes, and the pattern shapes may not be greatly changed depending on regions. In this case, even if the shaft 510 is moved, the change in the speckle pattern may not be recognized. Accordingly, the speckle patterns illustrated in FIGS. 8B and 8C may not be used instead of the conventional fine pattern.

Accordingly, the speckles of the metal material may be used instead of the conventional fine pattern engraved on the surface of the shaft 510. When the shaft 510 is formed of a metal material, the inherent speckle of the metal material may appear and thus the movement of the shaft 510 may be recognized.

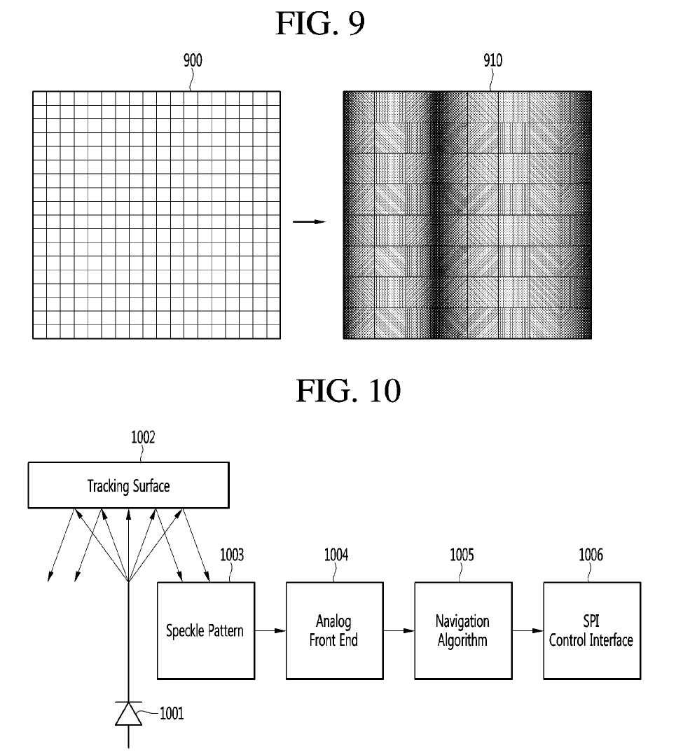

FIG. 9 is a view illustrating the structure of a sensor to recognize the speckle of the shaft in the watch-type mobile terminal according to an embodiment of the present invention.

To recognize the speckle 910 of the surface of the shaft 510, the sensor 900 may be formed in a matrix structure. In this case, the sensor 900 may include a plurality of recognition regions formed in a row and a column. Each of the recognition regions may have a square shape. Each of the recognition regions may recognize the pattern of the region of the speckle 910.

Referring to FIG. 9, the sensor 900 may have the matrix structure of 18×18. In this case, the sensor 900 has regions in 18 rows and 18 columns. In other words, the sensor 900 may include 324 recognition regions formed in 18 rows and 18 columns.

Meanwhile, in the case of the pattern of the speckle 910, the region of the speckle 910 having a higher reflection value from the surface of the shaft 510 represents white and the region of the speckle 910 having a lower reflection value from the surface of the shaft 510 may represent black.

FIG. 10 is a view illustrating the procedure of performing the computation for recognizing the movement of the shaft in the watch-type mobile terminal according to an embodiment of the present invention.

A light irradiation block 1001 emits light and irradiates light onto a target object 1002 to be tracked in movement thereof. In this case, the target object 1002 may be the shaft 510.

When light is irradiated onto the surface of the shaft 510, the irradiated light is reflected from the surface of the shaft 510 to form the speckle pattern. The speckle pattern may appear differently depending on the metal material constituting the shaft 510.

A speckle pattern block 1003 receives light reflected from the surface of the shaft 510 and acquires a speckle pattern from the reflected light. The acquired speckle pattern may be transmitted to an analog front end block 1004.

The analog front end block 1004 may receive the speckle pattern in the analog shape and may process the speckle pattern to be in a data form allowing a navigation algorithm.

The navigation algorithm block 1005 may recognize the movement of the shaft 510 through the navigation algorithm. In detail, when receiving data processed by the analog front end block 1004, the navigation algorithm block 1005 performs the navigation algorithm based on the input data. When the movement of the shaft 510 is recognized, the information on the movement of the shaft 510 may be transmitted to an SPI control interface block 1006.

The serial peripheral interface (SPI) control interface block 1006 provides a communication interface between parts or devices. In detail, when receiving information on the movement of the shat 510, the SPI control interface block 1006 makes communication with other components, devices, and parts to transmit the received information to the other components, devices, and parts.

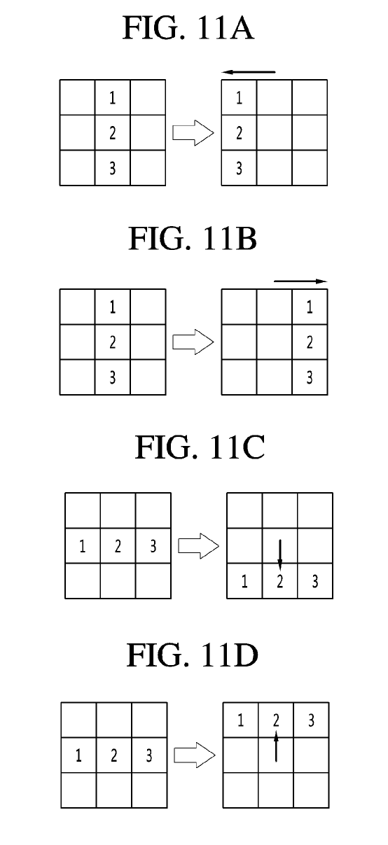

FIGS. 11A to 11D are views illustrating the method of recognizing the movement of the shaft in the watch-type mobile terminal, according to an embodiment of the present invention.

The shaft 510 formed of the metal material may include a plurality of regions. The patterns of the speckle regions corresponding to the regions may differently appear.

FIGS. 11A and 11B illustrate speckle patterns recognized by the sensor 900 when the shaft 510 is rotated. When the shaft 510 is rotated counterclockwise or clockwise, the speckle pattern corresponding to the rotation may be shifted leftward or rightward from the present position. In FIGS. 11A and 11B, the speckle pattern is assumed as reference numeral 123.

When the shaft 510 is rotated counterclockwise, the speckle pattern is shifted leftward. Referring to FIG. 11A, the speckle pattern is shifted leftward from the present position. In contrast, when the shaft 510 is rotated counterclockwise, the speckle pattern is shifted rightward. Referring to FIG. 11B, the speckle pattern is shifted rightward from the present position.

FIGS. 11C and 11D illustrate speckle patterns recognized by the sensor 900 when pressure is applied to the shaft 510. When the shaft 510 is pulled out or pressed toward the center of the watch-type mobile terminal 300, the speckle pattern corresponding thereto may be moved downward or upward from the present position. In FIGS. 11C and 11D, the speckle pattern is assumed as being 123.

When the shaft 510 is pulled out, the speckle pattern is moved downward. Referring to FIG. 11C, the speckle pattern is moved downward from the present position. In contrast, when the shaft 510 is pressed to be moved in the central direction, the speckle pattern is moved upward. Referring to FIG. 11D, the speckle pattern is moved upward from the present position.

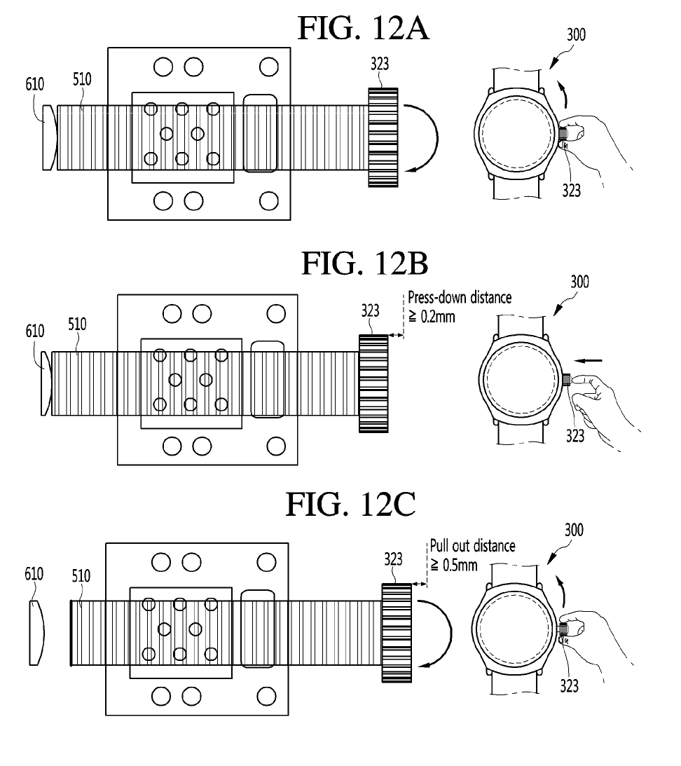

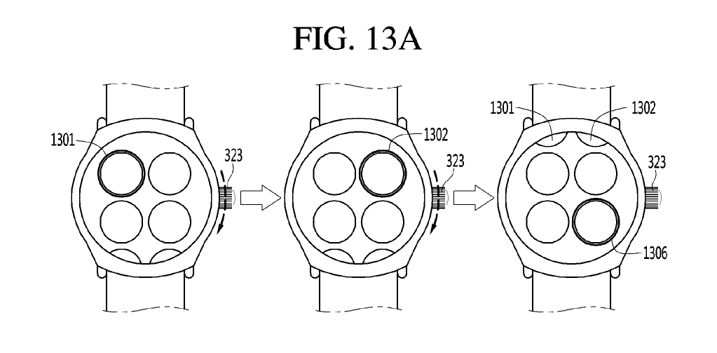

FIGS. 12A to 12C are views illustrating the operations of the crown that may be recognized by the watch-type mobile terminal according to an embodiment of the present invention.

The crown 323 may be rotated and may be pressed or pulled out by pressure applied thereto from the outside. In other words, the crown 323 may be operable in the state that the crown 323 is rotated and be pressed or pulled out by pressure applied thereto from the outside. In this case, the watch-type mobile terminal 300 may recognize the cases while distinguishing therebetween according to an embodiment of the present invention.

When the crown 323 is in the rotated state, there is absent pressure applied to the crown 323. Accordingly, since there is absent pressure transmitted to the dome switch 610, the dome switch 610 is not deformed. Referring to FIG. 12A, when the crown 323 is rotated, the dome switch 610 is maintained in an original state without being deformed.

When pressure is applied to the crown 323 toward the center of the watch-type mobile terminal, the crown 323 may be pressed toward the center of the watch-type mobile terminal. In this case, pressure is transmitted to the dome switch 610 so that the dome switch 610 is compressed. Referring to FIG. 12B, when the crown 323 is pressed, the dome switch 610 is compressed. The crown 323 may be pressed by 0.2 mm or more from the normal state in proportion to the compression degree of the dome switch 610.

When pressure is applied to the crown 323, the crown 323 may be pulled out. In this case, the crown 323 is spaced apart from the dome switch 610 so that the dome switch 610 is not deformed. Referring to FIG. 12C, when the crown 323 is pulled out, the crown 323 is spaced apart from the dome switch 610. The crown 323 may be pressed by 0.5 mm or more from the normal state in proportion to the drawing degree of the dome switch 610.

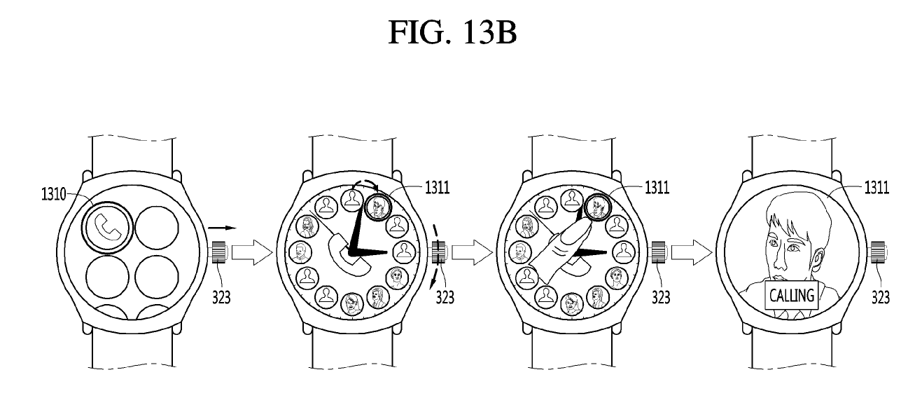

FIGS. 13A and 13B are views illustrating the method of controlling the watch-type mobile terminal according to an embodiment of the present invention.

When the above-described crown 323 having the novel structure is applied, the watch-type mobile terminal 300 may recognize the operation of pulling out the crown 323. In this case, the watch-type mobile terminal 300 may distinguish between the operation of rotating the crown 323 and an operation of rotating the crown 323 after pulling out the crown 323 and differently control UIs corresponding to the operations. In detail, when the watch-type mobile terminal moves a grid displayed on a screen one by one when the crown 323 is rotated. When the crown 323 is rotated while being pulled out, the watch-type mobile terminal 300 enters the grids, displays a plurality of detailed items, sequentially moves the detailed items one by one. In this case, the grid may be a graphic user interface (GUI) displaying an app or a menu.

FIG. 13A illustrates the case that the crown 323 is only rotated.

A plurality of grids may be displayed on the screen of the watch-type mobile terminal 300. The grids may be aligned based on a predetermined criterion. In this state, when the crown 323 is rotated, the highlighted grid may be sequentially shifted one by one corresponding to the rotation of the crown 323. Referring to FIG. 13A, a grid 1301, which displayed at the leftmost end portion of the first screen, is highlighted. In this state, when the crown 323 is rotated, a grid 1302 displayed at the rightmost end portion is highlighted. Thereafter, when the crown 323 is rotated to the end, a grid 1306 displayed at the rightmost end portion is finally highlighted.

FIG. 13B illustrates the case that the crown 323 is rotated while being pulled out.

When the crown 323 is rotated while being pulled out, the watch-type mobile terminal 300 may enter the grid and display details thereof. In detail, the watch-type mobile terminal 300 may enter the selected grid, display a plurality of detailed items, and sequentially shift the plurality of detailed items one by one.

As illustrated in FIG. 13B, when the crown 323 is pulled out in the state that a phone app icon 1310 is highlighted, a phone application is executed. In this case, the watch-type mobile terminal 300 may display the details of the phone app. For example, as illustrated in FIG. 13B, the list of a plurality of contacts may be displayed on a screen. The list of contacts may be arranged in the sequence of contacts which are frequently used. However, the present invention is not limited thereto. For example, according to the embodiment, the list of contacts may be arranged in the sequence of contacts which are recently called or may be arranged according to stored shortcut key numbers.

When the crown 323 is rotated clockwise or counterclockwise in the state that the crown 323 is pulled out, contacts may be sequentially shifted and highlighted one by one corresponding to the rotation of the crown 323. Referring to FIG. 13B, as the crown 323 is rotated, a contact 1311, which is displayed on a position shifted by one clockwise from a contact first highlighted, is highlighted. When an input signal to select the contact 1311 is detected, the watch-type mobile terminal 300 may call a phone number stored in the contact 1311.

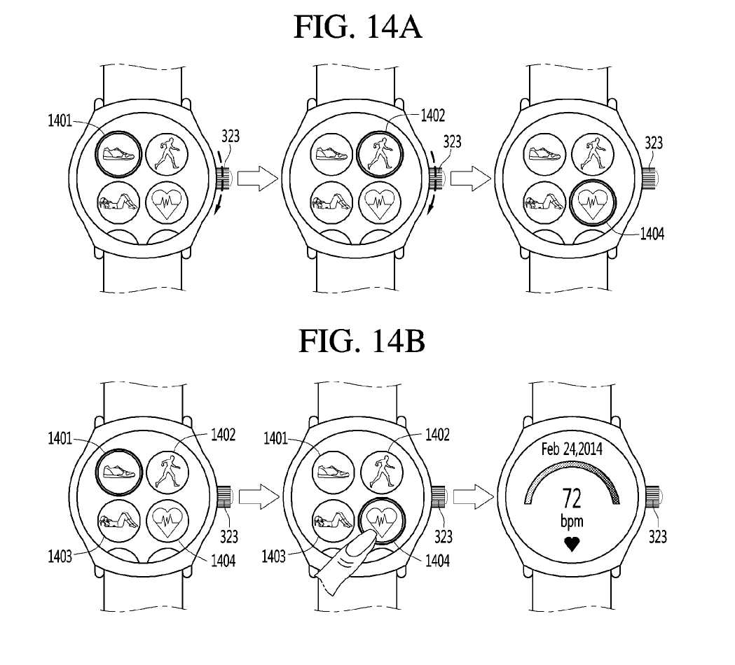

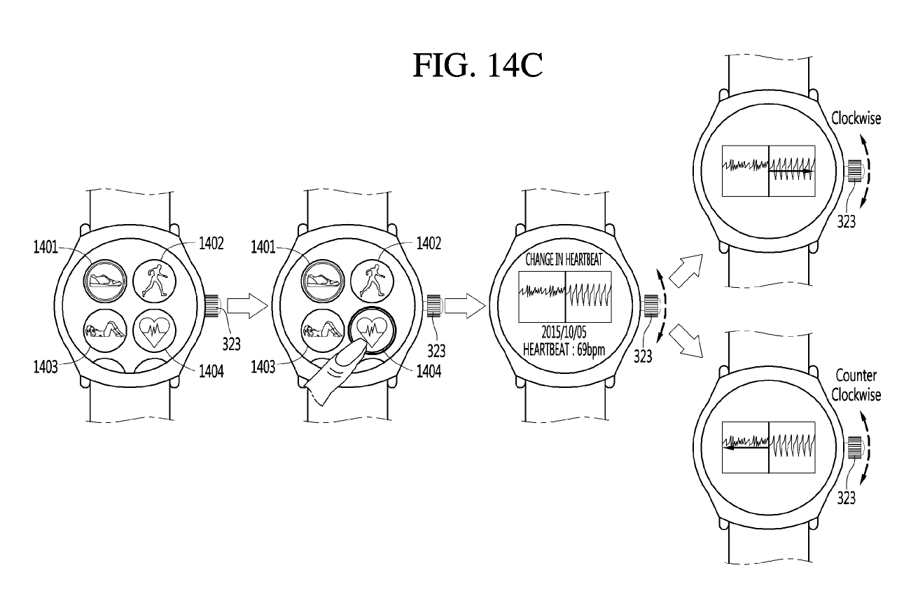

FIGS. 14A to 14C are views illustrating a method of controlling the watch-type mobile terminal according to an embodiment of the present invention.

A watch-type mobile terminal 300 shifts grids, which are displayed on the screen, one by one when the crown 323 is rotated. When the crown 323 is rotated in the state that the crown 323 is pulled out, the watch-type mobile terminal enters the grids and displays details. In this case, the watch-type mobile terminal may display the details according to the lapse of time. In detail, when the crown 323 is rotated clockwise, the detailed i information may be displayed according to the lapse of time from the present to the future. When the crown 323 is rotated counterclockwise, the details may be displayed according to the lapse of the time. Accordingly, the user may view the change of the selected details, which are changed according to the lapse of time, at a glace

FIG. 14A illustrates a case that the crown 323 only rotates.

As the crown 323 rotates, the grid highlighted on the screen may move one by one. In this case, the moving direction may be shifted from left to right and from top to bottom.

Referring to FIG. 14A, a grid 1401 displayed at the uppermost left side of the first displayed screen is highlighted. When the crown 323 rotates, a grid 1402 displayed at the uppermost right side is highlighted. Thereafter, the crown 323 continues to rotate, and a grid 1404 displayed at the lowermost right side may be highlighted.

FIG. 14B shows a case that the highlighted grid is selected and the relevant grid is executed.

When the highlighted grid is selected, the watch-type mobile terminal 300 may execute an app, menu, or function displayed on the selected grid. Referring to FIG. 14B, healthcare items are displayed on the screen of the mobile terminal 100. The grid 1401 displayed at the uppermost left side of the first displayed screen is highlighted. When the crown 323 rotates, the highlighted grid is shifted one by one. When an input signal for selecting a grid 1404 is sensed while the grid 1404 at the lowermost right side is highlighted, the grid 1404 is executed. In this case, since the selected grid 1404 is a function for measuring the heartbeat, the watch-type mobile terminal 300 measures the heartbeat of a relevant date and displays the heartbeat on the screen.

FIG. 14C shows a case that the crown 323 is rotated in the state that the crown 323 is pulled out.

The crown 323 may be rotated in the state that the crown 323 is pulled out. When the crown 323 is rotated in the state that the crown 323 is pulled out, the watch-type mobile terminal 300 may enter the grids, display details of the watch, and display the change of the details according to the lapse of time. In this case, the change of the details according to the lapse of time may be displayed toward the past time point or the future time point according to the rotation direction of the crown 323.

As illustrated in FIG. 14C, the healthcare items 1401, 1402, 1403, and 1404 highlighted are shifted one by one according to the rotation of the crown 323 in the state that the healthcare items 1401, 1402, 1403, and 1404 are displayed. When an input signal for selecting a heartbeat measuring function 1404 is sensed and the crown 323 is pulled out in the state that the heartbeat measuring function 1404 is highlighted, the details of the heartbeat measurement is displayed. In detail, not only the heartbeat of the measured date but also the change of the heartbeat according to the lapse of time may be displayed together.

If only the input signal for selecting the function 1404 is sensed in the state that the heartbeat measuring function 1404 is highlighted, the heartbeat measuring function 1404 is executed as illustrated in FIG. 14B and the measured heartbeat of the relevant date is displayed on the screen. Meanwhile, when the crown 323 is pulled out as illustrated in FIG. 14C, the detailed related to the executed function is displayed.

When the crown 323 is rotated, the change of the heartbeat according to the lapse of time may be displayed corresponding to the rotation of the crown 323. Specifically, when the crown 323 is rotated clockwise as illustrated in FIG. 14C, the change of the heartbeat from the present to the future time is displayed. The heartbeat at the future time point may be predicted based on the past data. In contrast, when the crown 323 is rotated counterclockwise, the change of the heartbeat from the present time point to the past time point is displayed. In this case, an arrow is displayed in the direction in which the change of the heartbeat is changed.

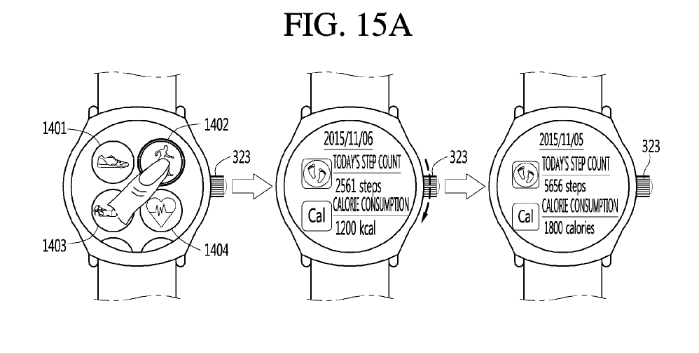

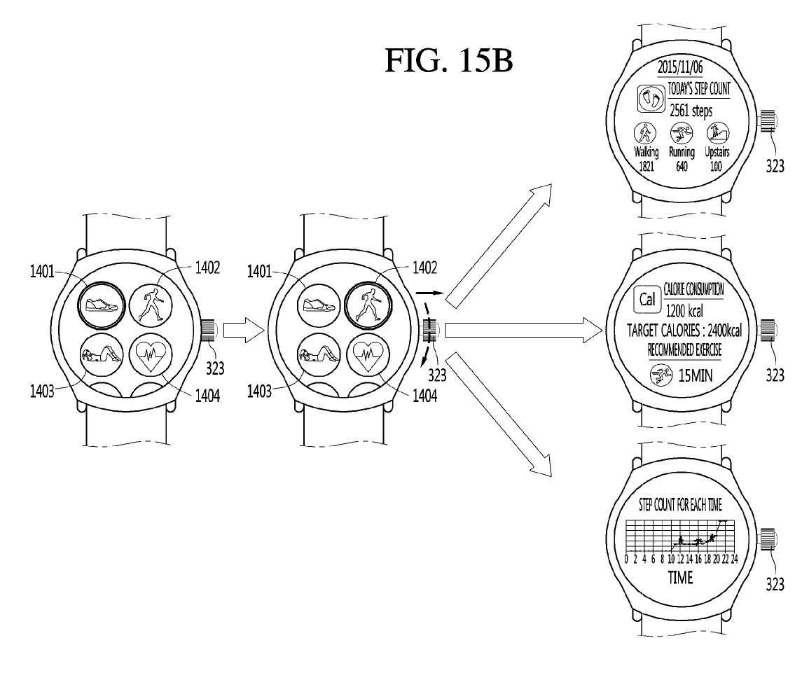

FIGS. 15A to 15B are views illustrating a method of controlling a watch-type mobile terminal according to an embodiment of the present invention.

The watch-type mobile terminal 300 may sequentially display information arranged in specific order when the crown 323 is rotated and may display, in detail, information stepwise when the crown 323 is rotated in the state that the crown 323 is pulled out.

FIG. 15A illustrates the case that the crown 323 is only rotated.

When the crown 323 is rotted, the watch-type mobile terminal 300 may sequentially display information sorted by date or time. In detail, when the crown 323 is rotated clockwise, information may be displayed such that the date or time increases in ascending order. In contrast, when the crown 323 is rotated counterclockwise, information may be displayed such that the date or time decreases in descending order.

Referring to FIG. 15A, in a state that a health management item 1402 at the right upper portion is highlighted, an input signal for selecting the item 1402 is sensed. Since the selected item 1402 relates to a step management function, information on the number of steps and calorie consumption on the relevant date may be displayed on the screen. In this state, when the crown 323 is rotated counterclockwise, dates are sorted in descending order and the number of steps and the calorie consumption on the relevant date may be displayed. In FIG. 15A, as the crown 323 is rotated counterclockwise, the number of steps and calorie consumption on the paste dates from the relevant date may be displayed on the screen.

FIG. 15B illustrates the case that the crown 323 is rotated in the state that the crown 323 is pulled out.

When the crown 323 is rotated in the state that the crown 323 is pulled out, the watch-type mobile terminal 300 may display, in detail, details on the selected function step by step. In other words, as the crown 323 is rotated, the content of the displayed details may be varied. Further, the content, the step, and the display degree of the details may be varied depending on the rotation degree of the crown 323.

As shown in FIG. 15B, in the state that the step management function 1402 is selected among healthcare items, the crown 323 may be pulled out. When the crown 323 is rotated in the state that the crown 323 is pulled out, the details of the step management function 1402 is displayed on the screen step by step corresponding to the degree of rotation of the crown 323.

When the crown 323 is rotated to some extent, information on the number of steps on the present date and the degree of exercise corresponding to the number of steps are displayed on the screen.

In this state, when the crown 323 is further rotated, information on calorie consumption, target calories, and recommended exercise on the present date are displayed on the screen.

When the crown 323 is still more rotated, the change of the number of steps according to the lapse of time may be displayed on the screen in the form of a graph.

As described above, the content of the details and the degree of display, which are displayed on the screen, may be varied step by step depending on the degree of rotation of the crown 323.

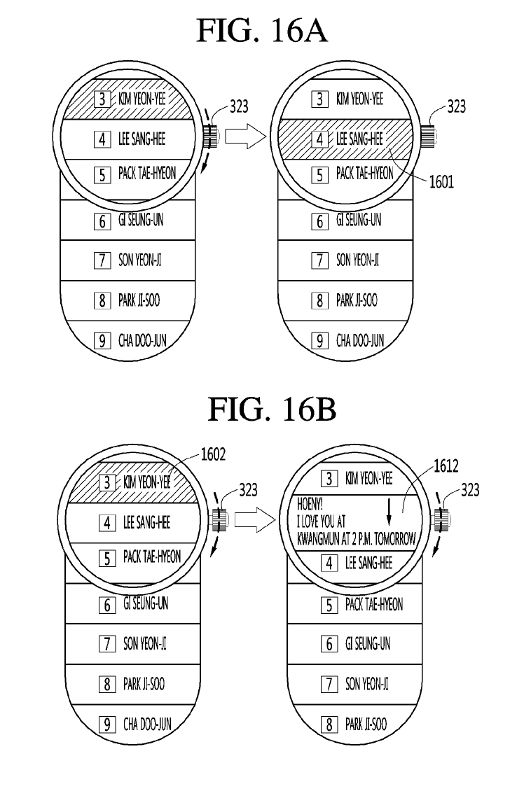

FIGS. 16A to 16B are views illustrating a method of controlling a watch-type mobile terminal according to an embodiment of the present invention.

When the crown 323 is rotated, the watch-type mobile terminal 300 shifts and highlights information displayed on the screen one by one. When the crown 323 is rotated in the state that the crown 323 is pulled out, the watch-type mobile terminal 300 displays the details of the selected information and scrolls the details.

FIG. 16A illustrates the case that the crown 323 is only rotated.

As the crown 323 is rotated, the highlighted information may be shifted one by one upward or downward. In detail, when the crown 323 is rotated clockwise, information to be highlighted is shifted upward one by one, and when the crown 323 is rotated counterclockwise, information to be highlighted may be shifted downward one by one.

Referring to FIG. 16A, the crown 323 is rotated counterclockwise and thus the fourth contact 1601 is highlighted.

FIG. 16B illustrates the case that the crown 323 is rotated in the state that the crown 323 is pulled out.

When the crown 323 is rotated in the state that the crown 323 is pulled out, the details of the selected information are displayed and the details may be scrolled corresponding to the rotation of the crown 323. Specifically, when the crown 323 is rotated counterclockwise, the details of the selected information are displayed, and when the crown 323 is rotated clockwise in the state that the details of the selected information are displayed, the displayed details disappear. Here, the details may be a text message exchanged with the relevant contact, a call history with the relevant contact, and the like.

As illustrated in FIG. 16B, the crown 323 is pulled out in a state that the third contact 1602 is highlighted. As a result, the details 1612 of the third contact 1602 are displayed. Specifically, a text message 1602 exchanged with the third contact 1602 may be displayed. In this state, when the crown 323 is rotated, the content of the text message 1612 exchanged with the third contact 1602 may be scrolled.

FIGS. 17A to 17D are views illustrating the structure of a typical mobile terminal.

FIG. 17A illustrates a rear view of the mobile terminal, and FIG. 17B illustrates the internal structure of the mobile terminal.

Referring to FIGS. 17A and 17B, the mobile terminal 100 includes a bar-shaped terminal body. In this case, the terminal body may be understood as a concept of referring to the mobile terminal 100 as the mobile terminal 100 is regarded as at least one assembly.

The mobile terminal 100 includes a case (e.g., a frame, a housing, or a cover) which forms an appearance. As illustrated in drawings, the mobile terminal 100 may include a front case 101 and a rear case 102. Various electronic components are disposed in the inner space formed by the combination of the front case 101 and the rear case 102. At least one intermediate case may be additionally disposed between the front case 101 and the rear case 102.

According to occasions, electronic components may also be mounted on the rear case 102. The electronic components that may be mounted on the rear case 102 include a detachable battery 191, an identification module, a memory card, and the like. In this case, a rear cover 103 for covering the mounted electronic components may be detachably coupled to the rear case 102. Therefore, when the rear cover 103 is separated from the rear case 102, the electronic components mounted on the rear case 102 are exposed to the outside

As illustrated in drawings, when the rear cover 103 is coupled to the rear case 102, a portion of the lateral side of the rear case 102 may be exposed. In some cases, the rear case 102 may be completely covered by the rear cover 103 during the coupling. Meanwhile, the rear cover 103 may have an opening for exposing a second camera 121b or a second sound output unit 152b to the outside.

The cases 101, 102 and 103 may be formed by injection molding of synthetic resin or may be formed of a metal such as stainless steel (STS), aluminum (Al), titanium (Ti) or the like.

The mobile terminal 100 may be configured such that one case provides the internal space, unlike the above example that a plurality of cases provide an internal space for receiving various electronic components. In this case, the mobile terminal 100 having a unified body formed as a synthetic resin or metal is connected from the lateral side to the rear side may be realized.

Meanwhile, the mobile terminal 100 may include a waterproof part (not shown) for preventing water from penetrating into the terminal body. For example, the waterproof part may include a waterproof meter which is interposed between a window 151a and a front case 101, between the front case 101 and a rear case 102, or between the rear case 102 and a rear cover 103 to seal the internal space when they are assembled with each other.

A second camera 121b may be disposed on the rear surface of the terminal body. In this case, the second camera 121b has a capturing direction which is substantially opposite to that of the first camera (not illustrated). In this case, the first camera (not illustrated) is provided on the front surface of the terminal to process an image frame of a still image or a moving picture obtained by the image sensor in a shooting mode or a video conference mode. The processed image frame may be displayed on the display unit 151 and may be stored in the memory 170.

The second camera 121b may include a plurality of lenses arranged along at least one line. The plurality of lenses may be arranged in a matrix form. Such a camera may be called an ‘array camera’. When the second camera 121b is configured with an array camera, images may be captured in various manners using a plurality of lenses, and a better quality image may be obtained.

A flash 124 may be adjacent to the second camera 121b. The flash 124 may irradiate light toward a subject when the subject is captured by using the second camera 121b.

The second sound output unit 152b may be additionally provided in the terminal body. The second sound output unit 152b may implement a stereo function together with a first sound output unit (not shown) provided on the front of the terminal, and may be used for implementing a speakerphone mode in a call. In this case, the first sound output unit (not illustrated) may be implemented in the form of a receiver for transmitting a call sound to a user's ear, and the second sound output unit 152b may be implemented in the form of a loud speaker to output various alarm sounds and multimedia reproduction sounds.

The microphone 122 is configured to receive the voice of a user, other sounds, and the like. Microphones 122 may be provided at a plurality of locations to receive stereophonic sound.

The battery 191 may be embedded in the terminal body or configured detachably from the outside of the terminal body. In this case, the battery 191 may be configured to receive power through a power cable connected to the interface unit 160. In addition, the battery 191 may be configured to be wirelessly chargeable through a wireless charger. The wireless charging may be implemented in a magnetic induction manner or a resonance manner (magnetic resonance manner).

Meanwhile, the present drawing illustrates that the rear cover 103 is configured to be coupled to the rear case 102 to cover the battery 191 such that the separation of the battery 191 is restricted and the battery 191 is protected from external impact and foreign matters. When the battery 191 is configured detachably from the terminal body, the rear cover 103 may be coupled to the rear case 102 detachably from the rear case 102.

Meanwhile, a rear surface input unit may be provided on a rear surface of the terminal body. The rear surface input unit is operated to receive a command for controlling the operation of the mobile terminal 100, and input content may be variously set. For example, a command such as power on/off, start, end, scroll, and the like, the adjustment of the size of the sound output from the second sound output unit 152b or a command to adjust the size of sound output from the second sound output unit 152b and to switch to the touch recognition mode may be received. The rear surface input unit may be implemented in the form of receiving a touch input, a push input, or the combination thereof.

The rear surface input unit may be disposed to be overlapped with the front display unit 151 in the thickness direction of the terminal body. For example, the rear input unit may be disposed at the rear upper end of the terminal body so that the user easily operates the terminal body when the user holds the terminal body with one hand.

When the rear surface input unit is provided on the rear surface of the terminal body, a user interface using the rear surface input unit may be implemented.

According to one embodiment, the rear surface input unit may include a first rear key 1710 and second rear keys 1720a and 1720b.

The first rear key 1710 may receive a command to turn on/off power, start, or end, scroll or a command to switch to the touch recognition mode. Further, the first rear key 1710 may is embedded therein with a fingerprint sensor to recognize the fingerprint of the user to receive the fingerprint of the user.

The second rear keys 1720a and 1720b may receive a command to scroll the mobile terminal 100 and a command to adjust the size of the sound output from the second sound output unit 152b.

To provide the first rear key 1710 and the second rear keys 1720a and 1720a on the rear surface of the terminal body, a space is provided in the rear surface of the terminal body such that the keys are embedded in the rear surface of the terminal body. In addition, a space for providing the second camera 121b is required. Referring to FIG. 17B, a space A for the second camera 121b, the first rear key 1710 and the second rear keys 1720a and 1720b are required in the rear surface of the terminal body. Accordingly, a space for embedding the battery 191 is reduced. Therefore, the capacity of the battery 191 may be reduced.

FIG. 17C shows a circuit board on which the second camera 121b, the first rear key 1710 and second rear keys 1720a and 1720b are disposed.

The circuit board illustrated in FIG. 17C may be disposed on the rear surface of the mobile terminal 100. The circuit board may include a connector region 1730 for connecting the rear keys 1710, 1720a and 1720b to the main board of the mobile terminal 100 and a connection region 1740 in which the second camera 121b is disposed.

The PCB area is wasted by the space in which the connector region 1730 and the connection region 1740 are mounted.

In addition, when the connector region 1730 and the connection region 1740 are inserted into the circuit board, the height of the rear surface of the mobile terminal 100 is increased. Accordingly, the use of parts having a higher thickness is restricted in the region for the rear keys 1710, 1720a, and 1720b.

FIG. 17D is a side view of the mobile terminal illustrated in FIG. 17A. As shown in FIG. 17D, the thickness of the mobile terminal 100 is increased by the rear keys 1710, 1720a, and 1720b.

If the rear keys are provided, the height of the part used on the rear surface is limited by inserting the connector region, and the thickness of the mobile terminal 100 is increased.

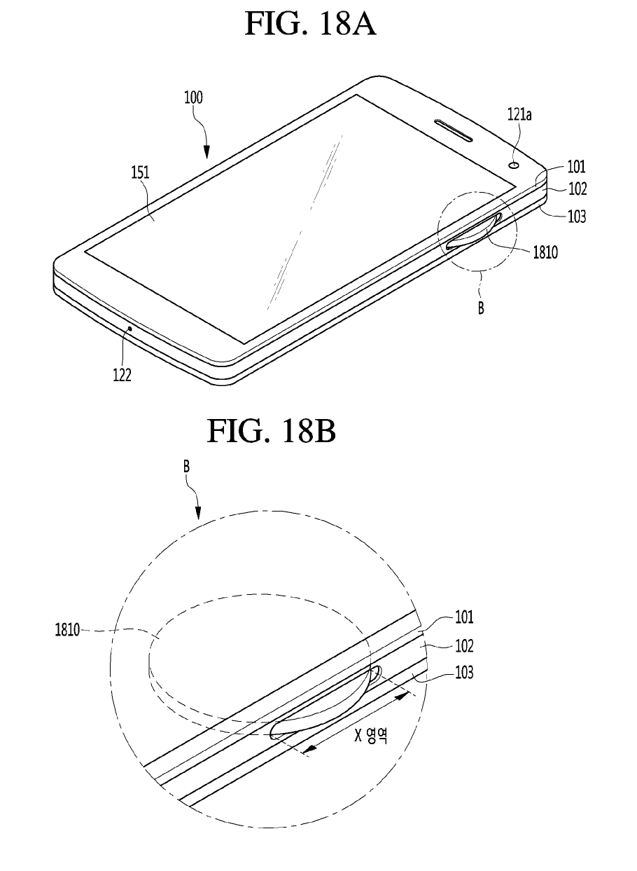

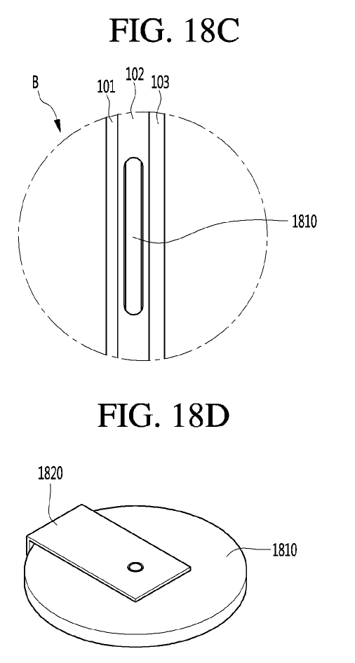

FIGS. 18A to 18D are views illustrating the structure of a mobile terminal and a wheel key included therein according to an embodiment of the present invention.

Referring to FIG. 18A, the mobile terminal 100 illustrated in FIG. 18 includes a bar-shaped terminal body. However, the present invention is not limited thereto, and is applicable to various structures such as a watch type, a clip type, a glass type, or a folder type, a flip type, a slide type, a swing type or a swivel type in which two or more bodies are movably coupled with each other.

The mobile terminal 100 may include a front case 101 and a rear case 102. Various electronic components are interposed in the inner space formed by the combination of the front case 101 and the rear case 102. In this case, a rear cover 103 for covering the mounted electronic component may be detachably coupled to the rear case 102. Since the front case 101, the rear case 102, and the rear cover 103 have been described above with reference to FIGS. 17A and 17B, the details thereof will not be described here.

A display unit 151 is disposed on a front surface of the terminal body to output information. A window of the display unit 151 may be mounted on the front case 101 to form a front surface of the terminal body together with the front case 101.

In addition, a first camera 121a may be provided on the front surface of the terminal body. The first camera 121a processes an image frame of a still image or a moving picture obtained by the image sensor in a capturing mode or a video converence mode. The processed image frame may be displayed on the display unit 151 and may be stored in the memory 170.

A microphone 122 is positioned on the side surface of the terminal body. Since the microphone 122 has been described with reference to FIGS. 17A and 17B, the details thereof will be omitted.

A wheel key 1810 may be provided on a side surface of the terminal body. The wheel key 1810 may be based on the novel structure of the crown 323 suggested by the present invention described above. The details of the wheel key and the method of recognizing the operation of the well-type key will be described later.

The wheel key 1810 may be used instead of the rear key provided on the rear surface of the terminal body. In this case, the area of the PCB occupied by the rear key may be reduced, thereby increasing the space for receiving the battery, reducing the height occupied by the rear key, and reducing the thickness of the mobile terminal 100.

As illustrated in FIG. 18A, the wheel key 1810 may be provided on the right side surface of the mobile terminal 100. Hereinafter, a region THAT the wheel key 1810 is provided is defined as a wheel key region B. Meanwhile, the wheel key 1810 may be disposed on the left side surface of the mobile terminal 100 according to an embodiment.

An enlarged view of the wheel key region B is illustrated in FIGS. 18B and 18C. In detail, FIG. 18B is an enlarged perspective view of the side surface of the wheel key region, and FIG. 18C is an enlarged view of the side surface of the wheel key region B.

As illustrated in FIGS. 18B and 18C, the wheel key 1810 is disposed in the inner space formed by the combination of the front case 101 and the rear case 102. In this case, the side surface of the rear case 102 may be provided therein with an opening for exposing a partial region (region X) of the wheel key 1810 to the outside. The partial region (region X) of the exposed wheel key 1810 may be rotated by the user.

The wheel key 1810 may be rotated clockwise or counterclockwise, and may be rotatable at 360 degrees. Depending on the rotation direction or the rotation angle of the wheel key 1810, the mobile terminal 100 may execute or control the app or the function.

The wheel key 1810 may be formed of a metal material. In this case, the wheel key 1810 may reflect the light irradiated onto the surface thereof to form a speckle pattern.

FIG. 18D illustrates the coupling structure between the wheel key 1810 and a wheel key support 1820.

The wheel key 1810 may be fixed and supported by the wheel key support 1820.

In detail, the wheel key support 1820 may be coupled to the center of the wheel key 1810 by a fixing shaft to fix the center of the wheel key 1810. Accordingly, even if the wheel key 1810 is rotated, the center of the wheel key 1810 is not moved.

In addition, the wheel key support 1820 may be formed in a closed structure with respect to the opposite side surface of the surface that the wheel key 1810 is exposed to the outside of the mobile terminal 100. Thus, even if the wheel key 1810 is pressed during the rotation of the wheel key 1810, the wheel key 1810 is not inserted into the mobile terminal 100.

The wheel key support 1820 may be formed of a material such as synthetic resin or metal. The wheel key support 1820 may have a rectangular shape as shown in FIG. 18D, but the present invention is not limited thereto. As long as the above-described functions may be performed, the shape of the wheel key support 1820 may be modified according to embodiments.

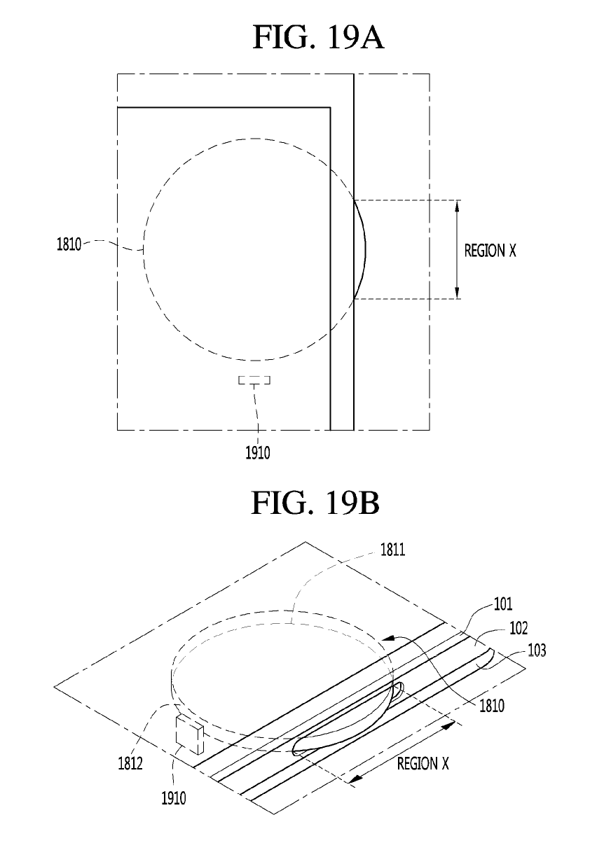

FIGS. 19A and 19B are views illustrating one example of the wheel key region provided in the mobile terminal according to an embodiment of the present invention.

FIG. 19A is a font view of the wheel key region and FIG. 19B is a perspective view of the side surface of the wheel key region.

The wheel key region may include the wheel key 1810 and a pattern recognizing unit 1910.

The wheel key 1810 may correspond to the shaft 510 illustrated in FIG. 7 and the pattern recognizing unit 1910 may correspond to the package circuit board 520 illustrated in FIG. 5B.

As illustrated in FIGS. 19A and 19B, the pattern recognizing unit 1910 may be positioned at the lower end of a wheel key side surface 1812. In this case, the pattern recognizing unit 1910 irradiates light toward the wheel key side surface 1812, and the irradiated light is reflected from the wheel key side surface 1812 to generate reflected light. In this case, the pattern recognizing unit 1910 may receive the reflected light and may recognize the speckle pattern of the wheel key side surface 1812.

The wheel key 1810 may be rotated clockwise or counterclockwise. In this case, the speckle pattern of the wheel key side surface 1812 recognized by the pattern recognizing unit 1910 may be varied depending on the rotation direction and the rotation angle of the wheel key 1810.

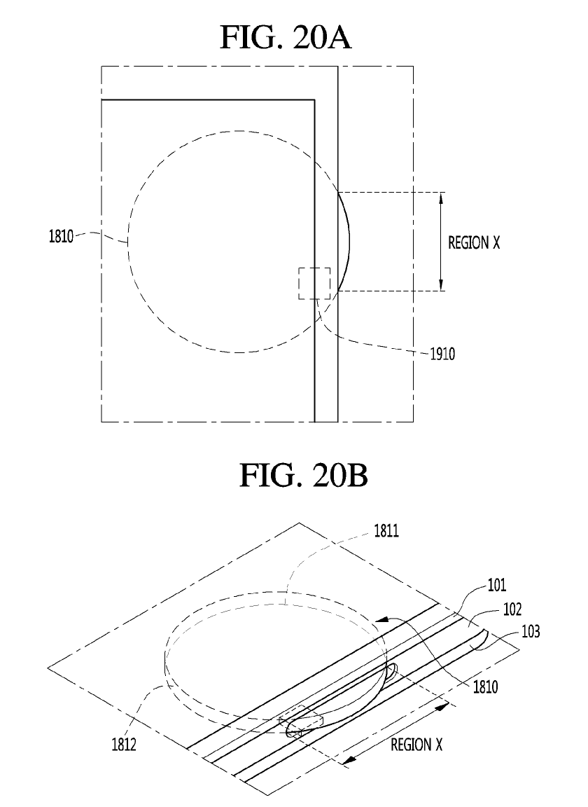

FIGS. 20A and 20B are views illustrating another example of a wheel key region included in a mobile terminal according to an embodiment of the present invention.

20A is a front view of the wheel key region, and FIG. 20B is a perspective view of the side surface of the wheel key region.

As illustrated in FIGS. 20A and 20B, the pattern recognizing unit 1910 may be positioned at the lower end of a wheel key rear surface 1811. In this case, the pattern recognizing unit 1910 irradiates light toward the wheel key rear face 1811, and the irradiated light is reflected from the wheel key rear surface 1811 to generate the reflected light. In this case, the pattern recognizing unit 1910 may receive the reflected light and may recognize the speckle pattern of the wheel key rear surface 1811.

The wheel key 1810 may be rotated clockwise or counterclockwise. In this case, the speckle pattern of the wheel key rear surface 1811 recognized by the pattern recognizing unit 1910 may be varied depending on the rotation direction and the rotation angle of the wheel key 1810.

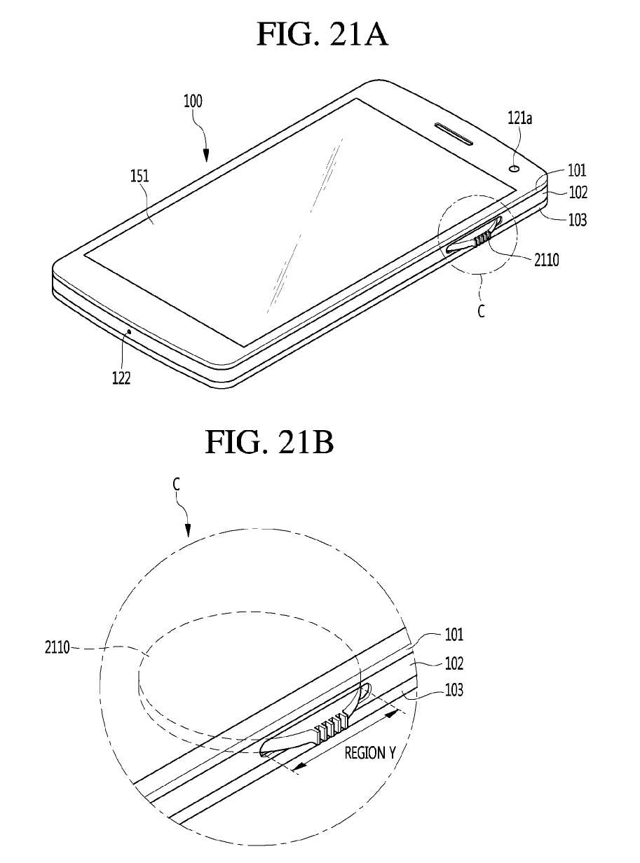

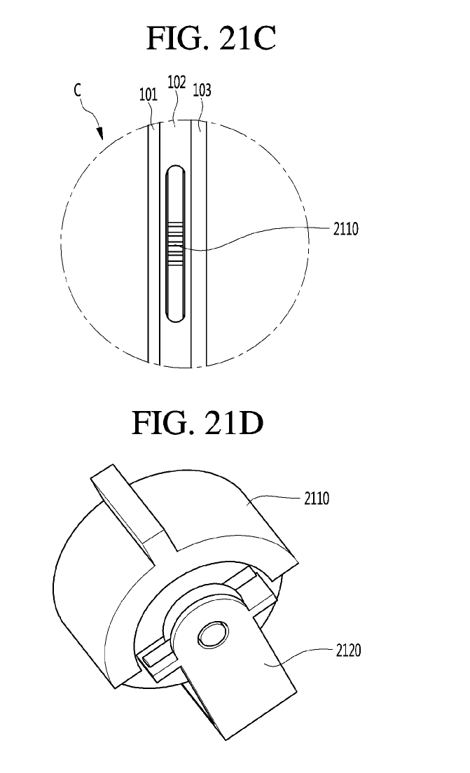

FIGS. 21A to 21D are views illustrating a wheel key included in a mobile terminal according to an embodiment of the present invention.

A wheel key 2110 may be provided on a side surface of the terminal body. As illustrated in FIG. 21A, the wheel key 2110 may be provided on the right side of the mobile terminal 100. However, the wheel key 1810 may be disposed on the left side of the mobile terminal 100 according to an embodiment.

A wheel key region C including the wheel key 2110 is positioned on the right side of the mobile terminal 100. An enlarged view of the wheel key region C is illustrated in FIGS. 21B and 21C. In detail, FIG. 21B is an enlarged perspective view of a side surface of the wheel key region C, and FIG. 21C is an enlarged view of a side surface of the wheel key region C.

As illustrated in FIGS. 21B and 21C, the wheel key 2110 is disposed in the inner space formed by the combination of the front case 101 and the rear case 102. In this case, the side surface of the rear case 102 may be provided therein with an opening for exposing a partial region (region Y) of the wheel key 2110 to the outside. The partial region (region Y) of the exposed wheel key 2110 may be rotated by the user.

Unlike the wheel key 1810 described with reference to FIGS. 18A to 18D, the operation range of the wheel key 2110 illustrated in the present drawing may be limited. In detail, the wheel key 2110 is rotatable only within a predetermined range. For example, the wheel key 2110 may be rotated within a range of ±35 degrees with respect to the starting point.

The wheel key 2110 may be rotated clockwise or counterclockwise. When the wheel key 2110 is rotated to the maximum possible rotatable angle, the wheel key 2110 may be rotated again in the reverse direction.

In this case, the mobile terminal 100 may execute or control the app or function according to the rotation direction or the rotation angle of the wheel key 2110.

Meanwhile, a predetermined section of the partial region (region Y) of the exposed wheel key 2110 may be realized in a saw tooth shape.

The wheel key 2110 may be formed of a metal material. In this case, the wheel key 2110 may reflect the light irradiated onto the surface to form a speckle pattern.

FIG. 21D illustrates a connection structure of the wheel key 2110 and a torsion spring 2120.

The wheel key 2110 is connected to the torsion spring 2120. In this case, the wheel key 2110 is rotatable only within a predetermined angle at which the torsion spring 2120 is rotatable. The predetermined angle may be varied depending on the spring constant of the torsion spring 2120.

The torsion spring 2120 may be a spring that is elastically deformed by twisting. The spring constant of the torsion spring 2120 may be varied depending on the material of the torsion spring 2120. The torsion spring 2120 may be formed of a material having elasticity.

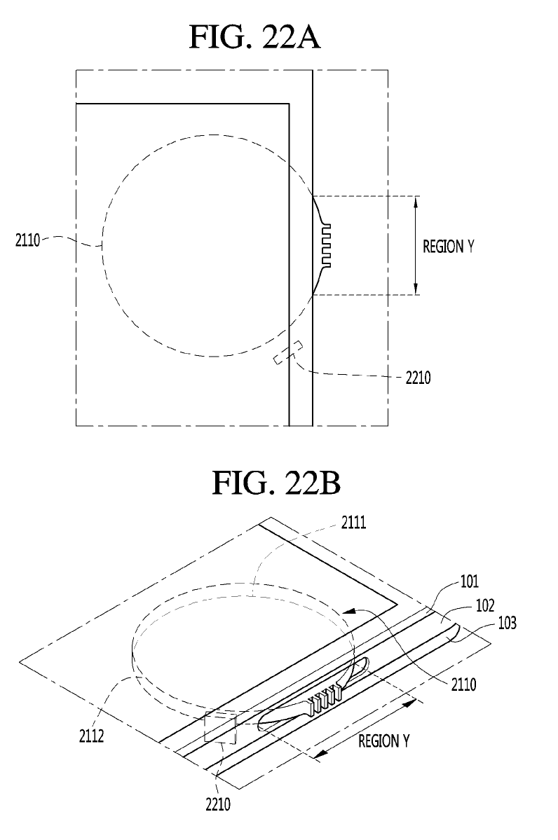

FIGS. 22A and 22B are views illustrating a wheel key region included in the mobile terminal according to an embodiment of the present invention.

FIG. 22A is a front view of a wheel key region, and FIG. 22B is a perspective view of the side surface of the wheel key region.

The wheel key region includes a wheel key 2110 and a pattern recognizing unit 2210.

The wheel key 2110 may correspond to the shaft 510 described above, and the pattern recognizing unit 2210 may correspond to the package circuit board 520.

The wheel key 2110 is rotatable only within a predetermined range as described with reference to FIG. 21A to 21D.

As illustrated in FIGS. 22A and 22B, the pattern recognizing unit 2210 may be inclined with respect to the lower end of a wheel key side surface 2112. In this case, the pattern recognizing unit 2210 irradiates the light toward the wheel key side surface 2112 and the irradiated light is reflected from the wheel key side surface 2112 to generate reflected light. In this case, the pattern recognizing unit 2210 receives the reflected light to recognize the speckle pattern of the wheel key side surface 2112.

The wheel key 2110 may be rotated clockwise or counterclockwise within a predetermined range. In this case, the speckle pattern of the wheel key side surface 2112 recognized by the pattern recognizing unit 2210 may be varied depending on the rotation direction and the rotation angle of the wheel key 2110.

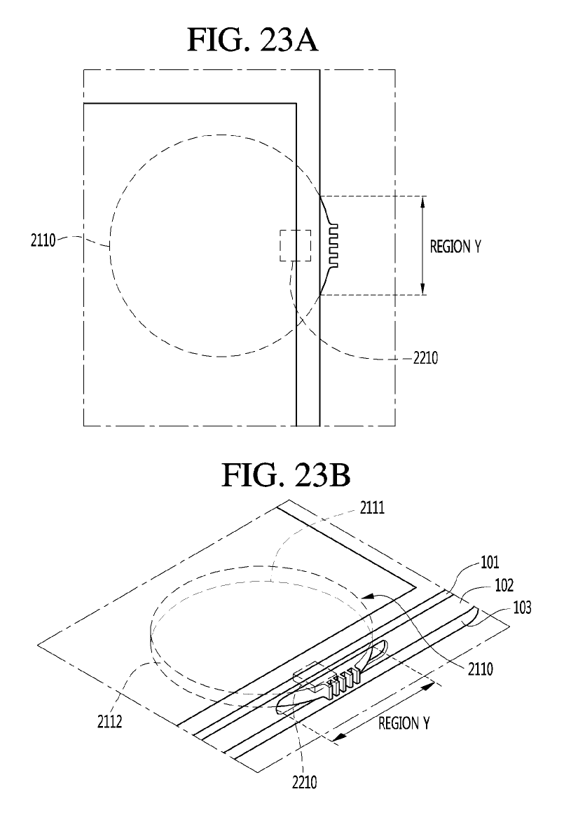

FIGS. 23A and 23B are views illustrating a wheel key region included in the mobile terminal according to an embodiment of the present invention.

FIG. 23A is a front view of the wheel key region, and FIG. 23B is a perspective view of the side surface of the wheel key region.

As illustrated in FIGS. 23A and 23B, the pattern recognizing unit 2210 may be positioned at the lower end of a wheel key rear surface 2111. In this case, the pattern recognizing unit 2210 irradiates the light toward the wheel key rear surface 2111 and the irradiated light is reflected from the wheel key rear surface 2111 to generate reflected light. In this case, the pattern recognizing unit 2210 receives the reflected light to recognize the speckle pattern of the wheel key rear surface 2111.

The wheel key 2110 may be rotated clockwise or counterclockwise within a predetermined range. In this case, the speckle pattern of the wheel key rear surface 2111 recognized by the pattern recognizing unit 2210 may be varied depending on the rotation direction and the rotation angle of the wheel key 2110.

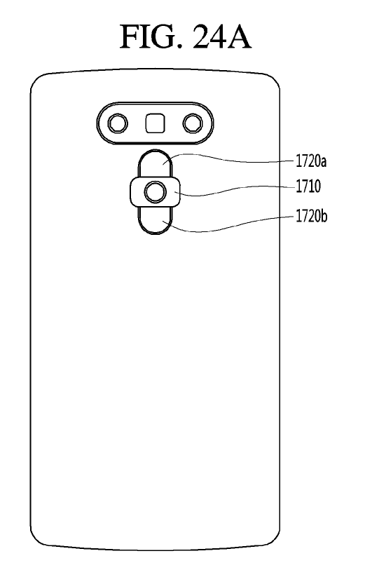

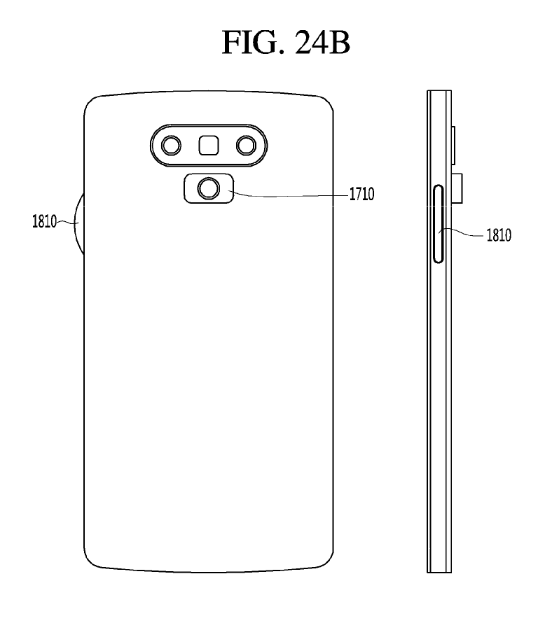

FIGS. 24A and 24B are views for comparing a mobile terminal according to an embodiment of the present invention with a typical mobile terminal in thickness.

FIG. 24A illustrates a rear view of the typical mobile terminal having a rear key, and FIG. 24B illustrates a rear view of a mobile terminal equipped with a wheel key according to an embodiment of the present invention.

As illustrated in FIG. 24A, the rear keys 1710, 1720a, and 1720b may be provided on the rear surface of the typical mobile terminal. The rear keys 1710, 1720a, and 1720b may be controlled in a button manner. In this case, the height of the rear surface of the mobile terminal is increased by the rear keys 1710, 1720a, and 1720b, and the space for mounting the battery is reduced by the PCB area that the rear keys 1710, 1720a, and 1720b are disposed.

The rear keys 1710, 1720a, and 1720b may include a first rear key 1710 switched in an ON/OFF manner and second rear keys 1720a and 1720b implemented in one pair as a control value is controlled to be increased or decreased.

In this case, the wheel key 1810 suggested by the present invention may be used instead of the second rear keys 1720a and 1720b. In other words, as illustrated in FIG. 24B, the second rear keys 1720a and 1720b may disappear from the rear surface, and the wheel key 1810 may be provided on the side surface of the mobile terminal 100.

The wheel key 1810 may be rotated clockwise or counterclockwise. Accordingly, the functions performed by the second rear keys 1720a and 1720b may be performed corresponding to the clockwise or counterclockwise rotation, respectively.

When the wheel key 1810 is provided on the side surface instead of the second rear keys 1720a and 1720b, the thickness of the mobile terminal 100 may be reduced by the height of the second rear keys 1720a and 1720b. In addition, the PCB area on the rear surface of the mobile terminal 100 may be increased by a space necessary for mounting the second rear keys 1720a and 1720b, thereby enlarging the space for mounting the battery. Referring to FIG. 24B, the second rear keys 1720a and 1720b disappear from the rear surface, so that the position of the first rear key 1710 is moved upward, so the space for mounting the battery may be increased.

Meanwhile, although FIGS. 24A and 24B illustrate the case that the wheel key 1810 is used instead of the second rear keys 1720a and 1720b, the wheel key 1810 may be used instead of the first rear key 1710 and the second rear keys 1720a and 1720b. In this case, the thickness of the rear surface of the mobile terminal 100 may be more reduced, and the space for mounting the battery may be more increased.

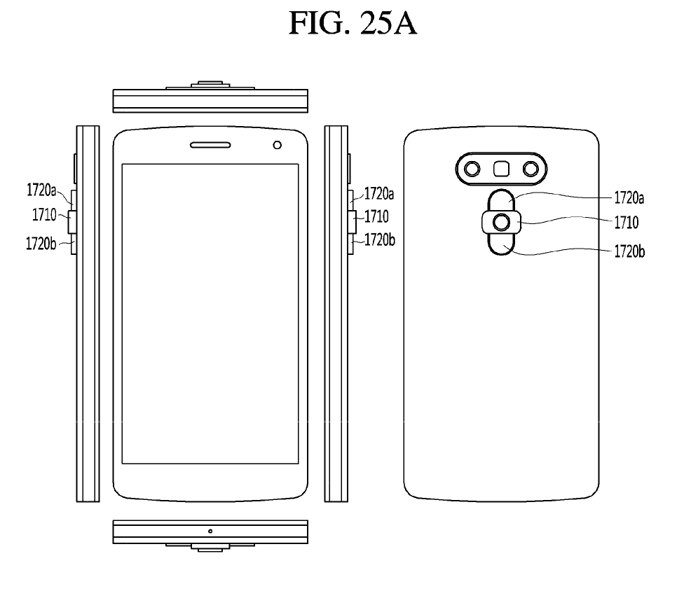

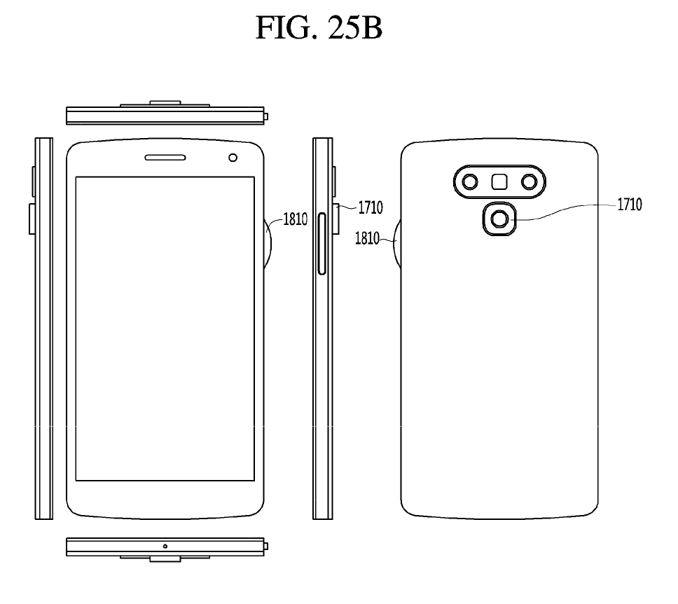

FIGS. 25A and 25B are views for comparing a mobile terminal according to an embodiment of the present invention with a typical mobile terminal in thickness.

FIG. 25A illustrates a front surface, a rear surface, both side surfaces, and both back surfaces in the typical mobile terminal and FIG. 25B illustrates a front surface, a back surface, both side surfaces, and both rear surfaces in a mobile terminal having a wheel key according to an embodiment of the present invention.

As illustrated in FIG. 25A, rear keys 1710, 1720a, and 1720b may be provided on a rear surface of the typical mobile terminal. In this case, as illustrated in the side view of FIG. 25A, the height of the rear surface of the mobile terminal may be increased by the height of the rear keys 1710, 1720a, and 1720b. In addition, as illustrated in the rear view of FIG. 25A, the space for mounting the battery may be reduced corresponding to the positions that the rear keys 1710, 1720a, and 1720b are disposed.

When the wheel key 1810 suggested in the present invention is used instead of the second rear keys 1720a and 1720b, the second rear keys 1720a and 1720b disappear from the rear surface of the mobile terminal and the wheel key 1810 is provided on a side surface of the terminal 100 as illustrated in FIG. 25B. In this case, as illustrated in the side view of FIG. 25B, the height of the rear surface of the mobile terminal is reduced by the height of the second rear keys 1720a and 1720b. In addition, as illustrated in the rear view of FIG. 25B, the space occupied by the second rear keys 1720a and 1720b disappears, and the first rear key 1710 is positioned up. Accordingly, the space for mounting the battery may be increased.

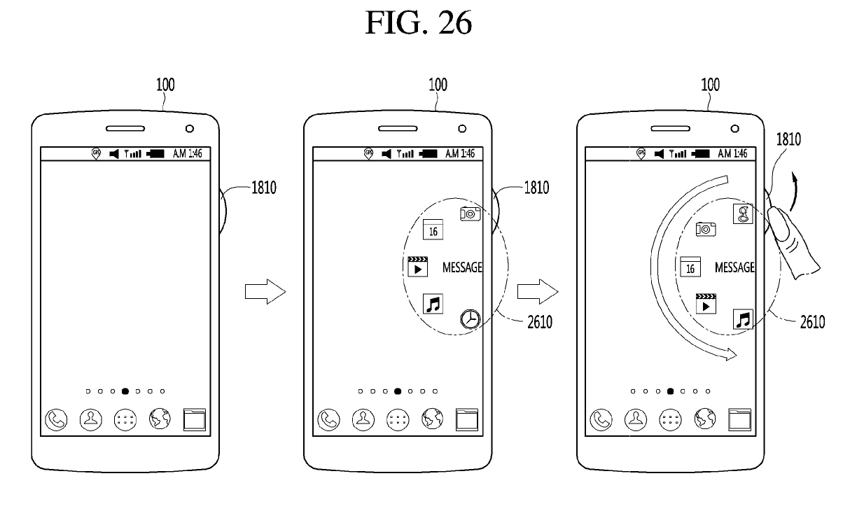

FIG. 26 is a view illustrating an example of controlling a mobile terminal by using a wheel key according to an embodiment of the present invention.

According to one embodiment of the present invention, the display positions of a plurality of icons 2610 may be rotated as the wheel key 1810 is rotated. In detail, when the wheel key 1810 is pressed by external pressure, a plurality of icons 2610, which may be controlled by the wheel key 1810, are displayed on the screen of the mobile terminal 100. The plurality of icons 2610 may be arranged and displayed in a circular shape.

In this case, the display positions of the plurality of icons 2610 may be rotated corresponding to the rotation of the wheel key 1810. In detail, when the wheel key 1810 rotates clockwise, the display positions of the plurality of icons 2610 may be rotated clockwise, and when the wheel key 1810 rotates counterclockwise, the display positions of the plurality of icons 2610 may be rotated counterclockwise.

As illustrated in FIG. 26, the wheel key 1810 is pressed by external pressure. Accordingly, the plurality of icons 2610 are displayed on the screen of the mobile terminal 100. In this state, when the wheel key 1810 moves counterclockwise, the plurality of icons 2610 are rotated and displayed rotated counterclockwise.

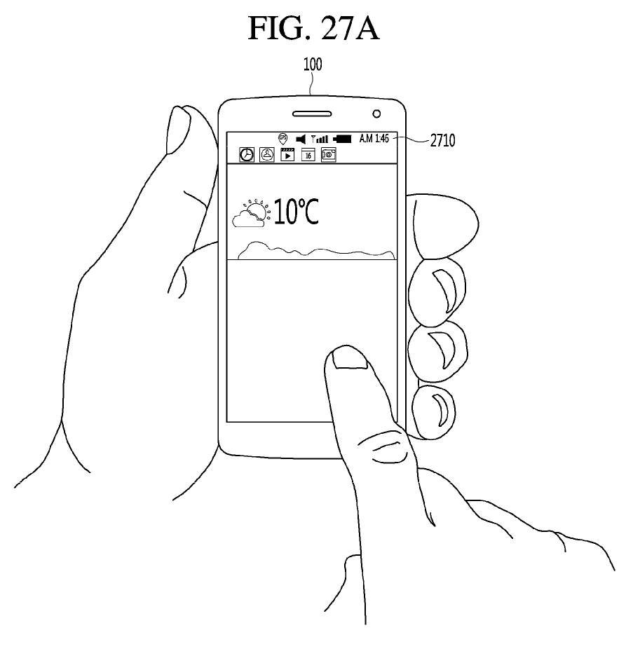

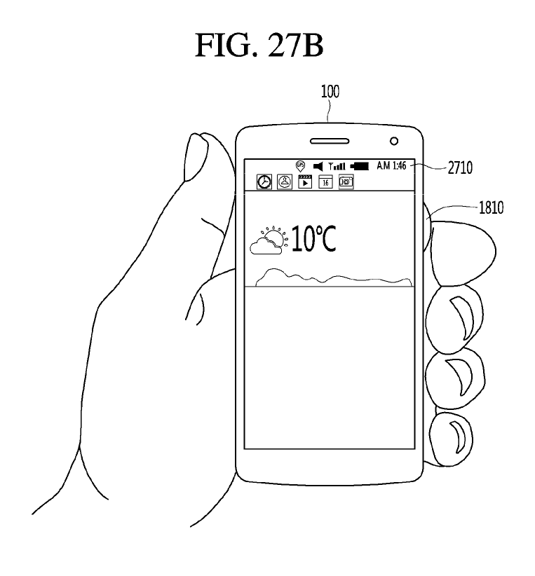

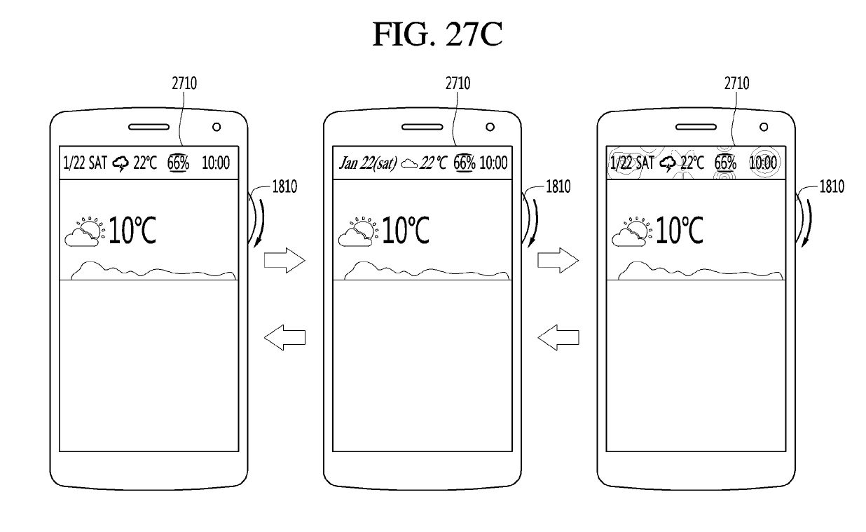

FIGS. 27A to 27C are views illustrating an example of controlling a mobile terminal by using according to an embodiment of the present invention.

FIG. 27A illustrates a conventional method of controlling a second screen 2710 in the mobile terminal 100. The second screen 2710 is a screen distinguished from the main screen, and may be located at the upper portion of the screen of the mobile terminal 100. Information such as a network, a network connection status, a battery remaining amount, a date and time, an app related notification message, and the like may be displayed on the second display 2710. The second screen 2710 may also be displayed in a locked state where the main screen is not activated.

As illustrated in FIG. 27A, when the user holds the mobile terminal 100 with his or her left hand, the user may control the second screen 2710 using the right-handed finger. Thus, conventionally, the user has to use both hands to control the second screen.

FIGS. 27B and 27C illustrate a method of controlling the second screen 2710 in the mobile terminal 100 according to an embodiment of the present invention.

When the wheel key 1810 is provided on the side surface of the mobile terminal 100, the user may control the mobile terminal 100 with one hand. As illustrated in FIG. 27B, when the user holds the mobile terminal 100 with his or her left hand, the user may control the wheel key 1810 positioned on the right side of the mobile terminal 100 using the index finger of the left hand. Meanwhile, although FIG. 27B illustrates an example that the wheel key 1810 is provided on the right side surface of the mobile terminal 100, the present invention is not limited thereto. The wheel key 1810 may be provided on the left side surface of the mobile terminal 100 according to the embodiment. In this case, the user may hold the mobile terminal 100 with his right hand and control the mobile terminal by using the index finger of the right hand.

When the wheel key 1810 is rotated, the second screen 2710 displayed at the upper portion may be controlled corresponding to the rotation of the wheel key 1810. In detail, when the wheel key 1810 is rotated clockwise or counterclockwise, the theme of the second screen 2710 may be changed corresponding to the rotation direction of the wheel key 1810. Referring to FIG. 27C, as the wheel key 1810 is rotated, a form of displaying the theme of the second screen 2710, that is, an app or an icon displayed on the second screen 2710 is changed.

As illustrated in FIGS. 27A to 27C, the user may easily control the second screen 2710 of the mobile terminal 100 with only one hand.

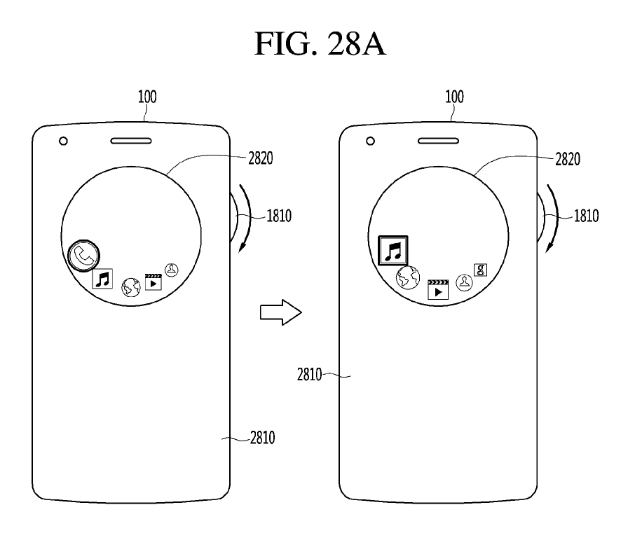

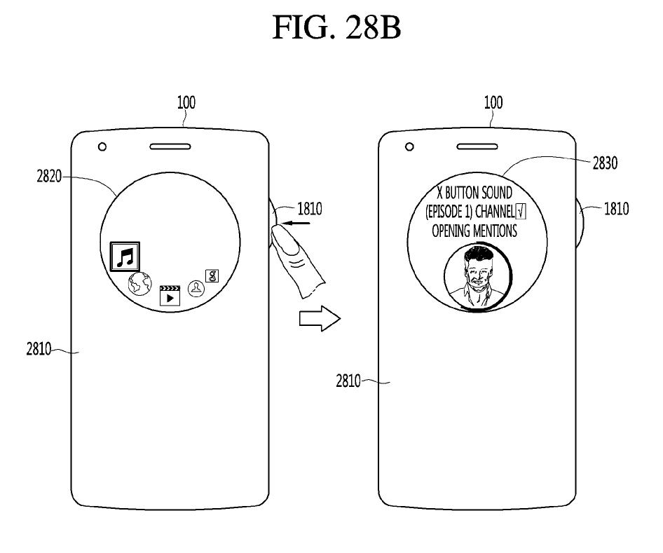

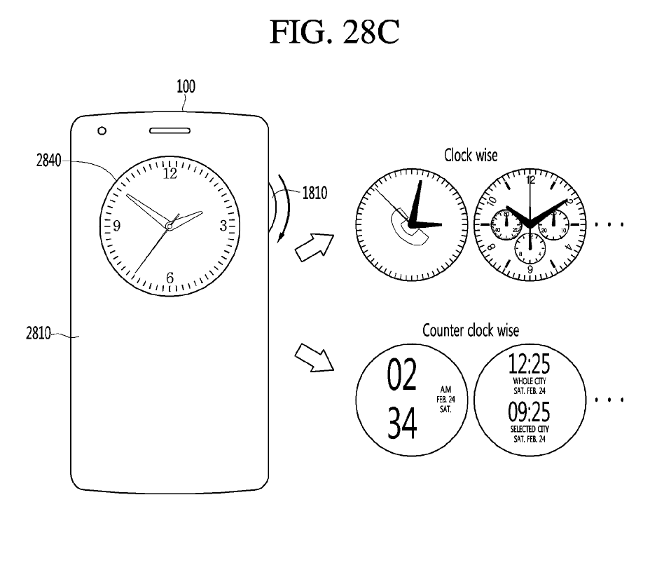

FIGS. 28A to 28C are views showing an example of controlling a mobile terminal by using a wheel key according to an embodiment of the present invention.

The mobile terminal 100 may be covered with a quick cover 2810. The quick cover 2810, which serves as a case of the mobile terminal 100, may include an electrostatic cover and a simple protection cover. The electrostatic cover is a cover in which the power is turned off when the cover is closed and the power is turned on when the cover is opened. The simple protection cover has no magnet on the closing side, does not power off even if being closed, and does not power on even if being open.

A screen display area 2820 for displaying a screen of the mobile terminal 100 may be present on the front surface of the quick cover 2810. The screen display area 2820 may be formed of a transparent material. Thus, an app icon, a menu, and a function displayed on the screen of the mobile terminal 100 may be viewed.

In this case, the app icon, the menu, and the function may be displayed corresponding to the screen display area 2820. Specifically, when the screen display area 2820 has a circular shape, a plurality of app icons may be arranged clockwise or counterclockwise along the circumference of a circle corresponding to the screen display area 2820.

A wheel key 1810 having a structure suggested by the present invention is provided on a side surface of the mobile terminal 100. When the wheel key 1810 is rotated, the plurality of app icons displayed one the screen display area 2820 may be controlled corresponding to the rotation of the wheel key 1810.

As illustrated in FIG. 28A, the quick cover 2810 is covered on the mobile terminal 100. In this case, the screen display area 2820 is present on the front surface of the quick cover 2810. In this case, the plurality of app icons are arranged along the circumference of a circle corresponding to the screen display area 2820. When the wheel key 1810 is rotated, the plurality of app icons may be rotated corresponding to the rotation of the wheel key 1810.

In the state that any one of the app icons is highlighted, the wheel key 1810 may be pressed. In this case, the highlighted app icon may be selected. When the app icon is selected, a relevant app 2830 may be executed as illustrated in FIG. 28B.

An app displayed or executed on the screen display area 2820 may be controlled differently depending on the rotation direction of the wheel key 1810. For example, when a clock screen 2840 is displayed on the screen display area, the theme of the clock screen is changed when the wheel key 1810 is rotated clockwise. When the wheel key 1810 is rotated counterclockwise, the display form of the clock screen may be changed. As illustrated in FIG. 28C, as the wheel key 1810 is rotated clockwise, the clock screen may be changed to displayed clock screen themes. Meanwhile, as the wheel key 1810 is rotated counterclockwise, the clock screen may be changed to the displayed clock screen themes.

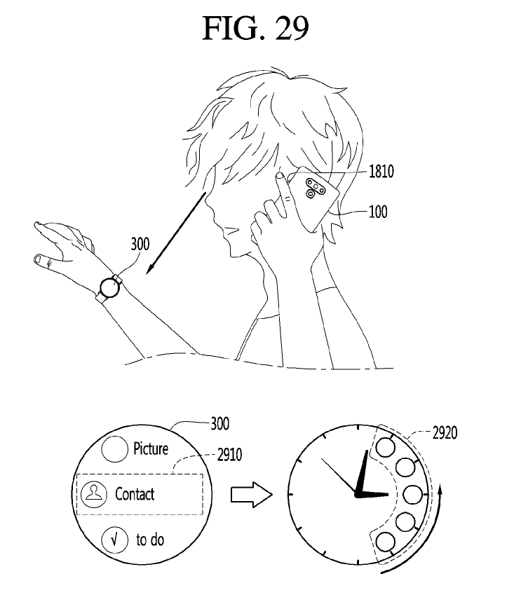

FIG. 29 is a view illustrating a control method by a mobile terminal and a watch-type mobile terminal according to an embodiment of the present invention.

When a user is on the phone by using the mobile terminal 100, the may execute and control the app or function of the mobile terminal 100 through the watch-type mobile terminal 300 put on the wrist of the user. In detail, the user may search for a telephone number department, a photograph, and a schedule stored in the mobile terminal 100 or the watch-type mobile terminal 300 through the watch-type mobile terminal 300.

Since one hand of the user grasps the mobile terminal 100 during a call, a user input may not be freely made through the watch-type mobile terminal 300. In addition, since the mobile terminal 100 is brought to the face of the user, the user may not view the screen of the mobile terminal 100. Accordingly, a user input to the mobile terminal 100 may be replaced with the user input to the watch-type mobile terminal 300.

When the user holds the mobile terminal 100 with one hand of the user, the user rotates the wheel key 1810 using the index finger. When the wheel key 1810 is rotated, the mobile terminal 100 transmits control information defined depending on the rotation direction and the rotation angle to the watch-type mobile terminal 300.

The watch-type mobile terminal 300 may control an app or a UI based on the control information received from the mobile terminal 100. As illustrated in FIG. 29, the contact list 2910 is selected corresponding to the rotation of the wheel key 1810. When the contact list 2910 is selected, a plurality of contacts 2920 included in the contact list 2910 are displayed in a circular form on the screen. In this state, when the wheel key 1810 is rotated, the plurality of contacts 2920 may be rotated and displayed corresponding to the rotation of the wheel key 1810.

Accordingly, the screen of the watch-type mobile terminal 300 may be controlled by controlling the wheel key 1810 provided on the side surface of the mobile terminal 100. Further, a user may simultaneously control the mobile terminal 100 and the watch-type mobile terminal 300 with one hand.

The present invention mentioned in the foregoing description may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal. The foregoing embodiments are merely exemplary and are not to be considered as limiting the present disclosure. The scope of the present invention should be considered broadly within its scope as defined in the appended claims, and therefore all changes and modifications that fall within the metes and bounds of the claims, or equivalents of such metes and bounds, are therefore intended to be embraced by the appended claims.

1. A watch-type mobile terminal comprising:
a crown including a shaft including a metal material and having a cylindrical rod shape;
a sensing unit to irradiate light to the shaft and recognize a reflective pattern of the metal material, which is formed as the light is reflected from a surface of the shaft; and
a controller to recognize an operation of the crown based on the reflective pattern of the metal material and control the watch-type mobile terminal corresponding to the operation of the crown.

2. The watch-type mobile terminal of claim 1, wherein the operation of the crown includes at least one of operation of being pressed toward the center of the watch-type mobile terminal, operation of being pulled out of the watch-type mobile terminal, operation of rotating clockwise or operation of rotating counterclockwise.

3. The watch-type mobile terminal of claim 1, wherein the shaft moves or rotates corresponding to the operation of the crown.

4. The watch-type mobile terminal of claim 1, wherein the controller recognizes the operation of the crown based on at least one of a moving direction, a moving sequence or a moving degree of the reflective pattern of the metal material.

5. The watch-type mobile terminal of claim 1, wherein the reflective pattern of the metal material is a speckle pattern of the metal material.

6. The watch-type mobile terminal of claim 1, wherein the shaft is configured to have a flat surface.

7. The watch-type mobile terminal of claim 1, wherein the sensing unit is positioned at a lower end of the shaft to irradiate light toward the shaft.

8. The watch-type mobile terminal of claim 1, wherein the metal material is aluminum (Al).

9. A mobile terminal comprising:
a wheel key provided at a side surface of the mobile terminal, including a metal material, and having a circular shape;
a sensing unit to irradiate light to the wheel key and recognize a reflective pattern of the metal material, which is formed as the light is reflected from a surface of the wheel key; and
a controller to recognize an operation of the wheel key based on the reflective pattern of the metal material and control the mobile terminal corresponding to the operation of the wheel key.

10. The mobile terminal of claim 9, wherein the operation of the wheel key includes at least one of operation of rotating clockwise or operation of rotating counterclockwise.

11. The mobile terminal of claim 9, wherein the controller recognizes the operation of the wheel key based on at least one of a moving direction, a moving sequence or a moving degree of the reflective pattern of the metal material.

12. The mobile terminal of claim 9, wherein the reflective pattern of the metal material is a speckle pattern of the metal material.

13. The mobile terminal of claim 9, wherein the wheel key is supported by a torsion spring to be rotated only within a predetermined angle range.

14. The mobile terminal of claim 9, wherein the wheel key substitutes for a rear key by performing a function of the rear key provided on a rear surface of the mobile terminal.

15. The mobile terminal of claim 9, wherein the sensing unit is positioned corresponding to one of a side surface, a rear surface or a front surface of the wheel key to irradiate the light to the any one of the side surface, the rear surface or the front surface of the wheel key.

16. The mobile terminal of claim 9, wherein the metal material is aluminum.

17. A method of operating a watch-type mobile terminal, the method comprising:
irradiating light to a shaft included in a crown, including a metal material, and having a cylindrical rod shape;
recognizing a reflective pattern of the metal material, which is formed as the light is reflected from a surface of the shaft;
recognizing operation of the crown based on the reflective pattern of the metal material; and
controlling the watch-type mobile terminal corresponding to the operation of the crown.

18. The method of claim 17, wherein the operation of the crown includes at least one of operation of being pressed toward the center of the watch-type mobile terminal, operation of being pulled out of the watch-type mobile terminal, operation of rotating clockwise or operation of rotating counterclockwise.

19. The method of claim 17, wherein the operation of the crown is recognized based on at least one of a moving direction, a moving sequence or a moving degree of the reflective pattern of the metal material.

20. The method of claim 17, wherein the reflective pattern of the metal material is a speckle pattern of the metal material.
